(19) United States
(12) Patent Application Publication
(10) Pub. No.: US 2007/0016495 A1
(43) Pub. Date: Jan. 18, 2007

(54) Systems, program products, and methods of enhancing financial budgeting of an organization

(75) Inventors: Larry J. McHaney, Mansfield, TX (US); Jerry W. Cook, Duncanville, TX (US)

Correspondence Address: BRACEWELL & GIULIANI LLP, P.O. BOX 61389, HOUSTON, TX, 77208-1389, US

(73) Assignee: Duncanville Independent School District, Duncanville, TX (US)

(21) Appl. No.: 11/168,189

(22) Filed: Jun. 28, 2005

(51) Int. Cl. G06Q 30/00

(52) U.S. Cl. 705/28

(57) ABSTRACT

Systems, program products, and methods to enhance financial budgeting of an organization having several departments are provided. A minimum budget assignor assigns to one of several departments a minimum budget amount of money. A strategy creator creates strategies for the department and a strategy assignor assigns a priority ranking determined by the department to each of the several of strategies to define several prioritized strategies. A strategy assignor assigns a priority ranking determined by the department to each of the strategies to define several prioritized strategies. A supplemental budget requestor submits several supplemental budget requests for the several prioritized strategies for a requested supplemental amount of money for each of the several supplemental budget requests of the department for review and approval by the organization. A supplemental budget assignor assigns to the department a supplemental budget amount of money determined by the organization for at least some of the several prioritized strategies.

### BACKGROUND OF THE INVENTION

1. Field of the Invention

The present invention relates generally to financial systems, program products, data structures, and methods and, more particuarly, to enhancing financial budgeting of an organization.

2. Description of Related Art

In organizations, such as educational institutions, it can be desired to discern the financial condition of the organization, including discerning the amount of money available for a future fiscal term, and then systematically allocating the money in the most sensible manner to departments of the organization to best achieve the goals and priorities of the organization. For example, a school district may have to distribute a finite amount of money to a number of school campuses under the jurisdiction of the school district. The school district, as well as each individual school campus, has a number of goals and priorities that may at times be unique to the conditions of the particular school district or school campus.

Prior methods of organizing, managing, and allocating budgets in an organization were chiefly based upon the organization first allocating an arbitrary amount of money to a department, and then having the department distribute the money in an ad hoc fashion until the department's funds were extinguished. The prior methods did not associate the amount of money allocated with the goals, objectives, and strategies of the school campus or school district at large, and therefore, no measures of accountability existed to expect or demand that the money be utilized in such a fashion to best achieve the goals and priorities of the organization and departments.

An alternative system is desired to reduce waste of financial resources, to redirect financial resources to meet the goals and priorities of the organization, and to create measures of accountability for both the organization at large and each of its departments that measure whether such goals and priorities are being met by the current allocation of resources.

### SUMMARY OF THE INVENTION

In view of the foregoing, embodiments of the present invention advantageously provide enhanced systems, program products, data structures, and methods of enhancing financial budgeting for an organization having a number of departments. The systems, program products, data structures, and methods have advantages and benefits of creating efficiencies which reduce the waste of time and financial resources. The invention advantageously redirects financial resources between an organization and its various departments to meet the goals and priorities of the organization. The invention also advantageously assists the organization in planning, as well as submission of its goals, objectives, and strategies to various governmental agencies. Through the combined budgeting and planning process, schools produce their required campus improvement plans for their benefit as well as for the benefit of the governmental agency to which the plans are submitted. The invention offers additional benefits of providing financial accountability for each budget item that is funded by measuring strategies and results to thereby allocate and utilize funds in the most efficient and successful manner.

For example, an embodiment of a system to enhance financial budgeting of a school district having several school campuses includes a computer defining a server and having a database and memory associated therewith. The server is adapted to interface with a communication network. The embodiment also includes a school district administrative computer adapted to interface with the communication network and a school district user. The school district administrative computer is adapted to be remote from and in communication with the server through the communication network. The embodiment also includes several school campus client computers each adapted to interface with the communication network and a school campus user. Each of the school campus client computers is adapted to be remote from and in communication with the server through the communication network. The embodiment further includes a program product stored in the memory of the server and adapted to be accessible by the school district administrative computer and the school campus client computers. The program product has instructions to perform the functionality of the system. A minimum budget assignor assigns to one of several school campuses a minimum budget amount of money determined by the school district so that the school campus expects to receive at least a minimum amount of money for the fiscal term. The minimum amount of money defines a final non-negotiated amount of money allocated from the school district to the school campus for the fiscal term. A budget scheduler creates a budget schedule for the fiscal term determined by the school campus. The budget schedule defines several budget items and a budget cost for each of the several budget items. A minimum budget indicator indicates on the budget schedule of the school campus when the sum of the budget costs for the several budget items on the budget schedule exceeds the minimum budget amount of money allocated to the school campus as determined by the school district. A budget item indicator indicates on the budget schedule of the school campus when the budget cost for the particular budget item exceeds the previous year's budget cost for the particular budget item. A goal creator creates several goals for the school campus. An objective creator creates several objectives for each of the several goals. A strategy creator creates several strategies for each of the objectives of each of the goals. A strategy assignor assigns a reasoned justification determined by the school campus that supports the necessity for a particular strategy to each of the several strategies. The strategy assignor then assigns a priority ranking determined by the school campus to each of the strategies based upon the reasoned justification to define several prioritized strategies. A supplemental budget requestor submits several supplemental budget requests for the prioritized strategies by the school campus to the school district for a requested supplemental amount of money for each of the several supplemental budget requests of the school campus. The supplemental budget requests are submitted to the school district for review and approval by the school district. The requested supplemental budget amount of money defines a negotiable amount of money independent of the non-negotiable amount of money that is requested from the school district by the school campus. A supplemental budget assignor assigns to the school campus a supplemental budget amount of money determined by the school district for at least some of the several prioritized strategies. The supplemental budget amount of money defines a final negotiated amount of money independent of the non-negotiable amount of money that is allocated from the school district to the school campus for the fiscal term. A budget reporter creates a report indicating the final non-negotiated amount of money and final negotiated amount of money for the fiscal term to thereby inform individuals within the school district and the school campus of the amount of money available for the fiscal term.

Embodiments of the present invention also provide a system to enhance financial budgeting of an organization having several departments. For example, an embodiment of the system includes a computer defining a server having a database and memory associated therewith. The server is adapted to interface with a communication network. The system also includes an organization administrative computer adapted to interface with the communication network and an organization user. The organization administrative computer is remote from and in communication with the server through the communication network. The system also includes several department client computers each adapted to interface with the communication network and a department user. Each of the several department client computers is remote from and in communication with the server through the communication network. The system further includes a program product stored in the memory of the server and accessible by the organization administrative computer and the department client computers. The program product has instructions to perform the functionality of the system. A minimum budget assignor assigns to one of the several departments a minimum budget amount of money determined by the organization so that the department expects to receive at least a minimum amount of money for the fiscal term. The minimum budget amount of money defines a final non-negotiated amount of money allocated from the organization to the department for the fiscal term. A strategy creator creates several strategies for the department. A strategy assignor assigns a priority ranking determined by the department to each of the several strategies to define several prioritized strategies. A supplemental budget requestor submits several supplemental budget requests for the prioritized strategies by the department to the organization for a requested supplemental amount of money for each of the several supplemental budget requests of the department. The supplemental budget requests are submitted to the organization for review and approval by the organization. The requested supplemental budget amount of money defines a negotiable amount of money independent of the non-negotiable amount of money that is requested from the organization by the department. A supplemental budget assignor assigns to the department a supplemental budget amount of money determined by the organization for at least some of the several prioritized strategies. The supplemental budget amount of money defines a final negotiated amount of money independent of the non-negotiable amount of money that is allocated from the organization to the department for the fiscal term.

Embodiments of the present invention also provide a program product embodied in a computer-readable medium to enhance financial budgeting of an organization having several departments. For example, an embodiment of the program product includes instructions to perform the functionality of the system. A minimum budget assignor assigns to one of the several departments a minimum budget amount of money determined by the organization so that the department expects to receive at least a minimum amount of money for the fiscal term. The minimum budget amount of money defines a final non-negotiated amount of money allocated from the organization to the department for the fiscal term. A strategy creator creates several strategies for the department. A strategy assignor assigns a priority ranking determined by the department to each of the several strategies to define several prioritized strategies. A supplemental budget requestor submits several supplemental budget requests for the prioritized strategies by the department to the organization for a requested supplemental amount of money for each of the several supplemental budget requests of the department. The supplemental budget requests are submitted to the organization for review and approval by the organization. The requested supplemental budget amount of money defines a negotiable amount of money independent of the non-negotiable amount of money that is requested from the organization by the department. A supplemental budget assignor assigns to the department a supplemental budget amount of money determined by the organization for at least some of the several prioritized strategies. The supplemental budget amount of money defines a final negotiated amount of money independent of the non-negotiable amount of money that is allocated from the organization to the department for the fiscal term.

Embodiments of the present invention, for example, also provide methods to enhance financial budgeting of an organization having several departments. An embodiment of a method, for example, includes assigning to one of the several departments a minimum budget amount of money determined by the organization so that the department expects to receive at least a minimum amount of money for the fiscal term. The minimum budget amount of money defines a final non-negotiated amount of money allocated from the organization to the department for the fiscal term. The method also includes creating several strategies for the department and assigning a priority ranking determined by the department to each of the several strategies to define several prioritized strategies. The method also includes submitting several supplemental budget requests for the several prioritized strategies by the department for a requested supplemental amount of money for each of the several supplemental budget requests of the department for review and approval by the organization. The requested supplemental budget amount of money defines a negotiable amount of money independent of the non-negotiable amount of money that is requested from the organization by the department. The method further includes assigning to the department a supplemental budget amount of money determined by the organization for at least some of the several prioritized strategies. The supplemental budget amount of money defines a final negotiated amount of money independent of the non-negotiable amount of money that is allocated from the organization to the department for the fiscal term.

Embodiments of the present invention further provide a computer memory element containing a database stored in signal bearing media. The database contains data in computer-readable format. The database, for example, includes data indicating an organizational structure, including data indicating an organization having several departments. The database also includes data indicating minimum budget allocation information for a preselected future fiscal term, including data indicating a minimum budget amount of money determined by the organization that the department is guaranteed for the fiscal term. The database also includes data indicating a plurality of strategies each having a priority ranking determined by the department to define several prioritized strategies. The database also includes data indicating supplemental budget request information for the fiscal term, including data indicating several supplemental budget requests for the several prioritized strategies by the department for a requested supplemental amount of money for each of the several supplemental budget requests of the department. The database further includes data indicating supplemental budget allocation information for the fiscal term, including data indicating a supplemental budget amount of money determined by the organization that is allocated to the department for at least some of the several prioritized strategies.

Embodiments of the systems, methods, and program products of the present invention include many advantages, benefits, and features, including enhancing the financial budgeting of an organization or school district having multiple departments or school campuses. Embodiments of the invention, for example, can ensure that the school campus receives a minimum budget amount of money for the fiscal term, typically as a percentage of the previous year's budget for the particular school campus, as determined by the school district. Further, for example, embodiments can advantageously indicate on the budget schedule of the school campus when the sum of the budget costs for the plurality of budget items on the budget schedule exceed the minimum budget amount of money allocated to the school campus as determined by the school district. Further, for example, embodiments can advantageously indicate on the budget schedule of the school campus when the budget cost for any particular budget item exceeds the previous year's budget cost for the particular budget item.

Embodiments of systems, methods, and program products include other important benefits and features, including the ability to advantageously assign priority rankings to each of a number of strategies of the school campus based upon reasoned justifications, as determined by the school district. Embodiments can advantageously assign to the school campus a supplemental budget amount of money determined by the school district for the prioritized strategies as the school district sees fit. Embodiments can additionally advantageously assign the priority rankings by having a number of voters selected by the school campus assign a numerical value in a preselected range of values (for example the values 0, 1, and 2) to each of the strategies, and then determining the sum of the values assigned to each strategy. The priority ranking is advantageously derived from comparing the sum total for each strategy of the school campus with the sum total for the other strategies of the school campus. The priority ranking is ultimately submitted by the school campus to the school district for review as part of the process of deciding the relative negotiable supplemental budget amounts of money allocated to each strategy of each school campus within the school district.

Some embodiments of systems, methods, and program products also, for example, can include benefits and features that can devise a report indicating the final non-negotiated minimum budget amount of money and the final negotiated supplemental budget amount of money for the fiscal term. In addition, embodiments can also transmit a report of a number of goals, objectives, and strategies for the school campus to a governmental agency to fulfill legal obligations related to submission of school campus goals, objectives, and strategies.

### BRIEF DESCRIPTION OF THE DRAWINGS

Some of the features, advantages, and benefits of the present invention having been stated, others will become apparent as the description proceeds when taken in conjunction with the accompanying drawings, in which:

FIG. 1 is a schematic diagram of a system to enhance financial budgeting of an organization according to an embodiment of the present invention;

FIG. 2 is another schematic diagram of a system to enhance financial budgeting of an organization according to an embodiment of the present invention;

FIG. 3 is another schematic diagram of a system to enhance financial budgeting of an organization according to an embodiment of the present invention;

FIG. 4 is a block diagram of a computer program product to enhance financial budgeting of an organization according to an embodiment of the present invention;

FIG. 5 is a block diagram of a computer program product to enhance financial budgeting of an organization according to an embodiment of the present invention;

FIG. 6 is a flow diagram of operations of a system to enhance financial budgeting of an organization according to an embodiment of the present invention;

FIG. 7 is a flow diagram of operations of a system to enhance financial budgeting of an organization according to an embodiment of the present invention;

FIG. 8 is a screen view (i.e., front plan view) from a department user interface displaying the table of contents for a non-negotiable budget of a department of an organization according to an embodiment of the present invention;

FIG. 9 is a screen view displaying a table of contents for allocations of a non-negotiable budget of a department of an organization according to an embodiment of the present invention;

FIG. 10 is a screen view displaying block allocations of a non-negotiable budget of a department of an organization according to an embodiment of the present invention;

FIG. 11 is a screen view displaying the table of contents for the allocation budget plan of a non-negotiable budget of a department of an organization according to an embodiment of the present invention;

FIG. 12 is a screen view displaying fields to add or edit goals of a non-negotiable budget of a department of an organization according to an embodiment of the present invention;

FIG. 13 is a screen view displaying fields to copy goals of a non-negotiable budget of a department of an organization according to an embodiment of the present invention;

FIG. 14 is a screen view displaying fields to add or edit objectives of a non-negotiable budget of a department of an organization according to an embodiment of the present invention;

FIG. 15 is a screen view displaying fields to add or edit strategies of a non-negotiable budget of a department of an organization according to an embodiment of the present invention;

FIG. 16 is a screen view displaying fields to add or edit requests for strategies of a non-negotiable budget of a department of an organization according to an embodiment of the present invention;

FIG. 17 is a screen view displaying non-negotiable budget items for a department of an organization according to an embodiment of the present invention;

FIG. 18 is a screen view displaying the table of contents for a negotiable budget of a department of an organization according to an embodiment of the present invention;

FIG. 19 is a screen view displaying fields to copy goals of a negotiable budget of a department of an organization according to an embodiment of the present invention;

FIG. 20 is a screen view displaying fields to add or edit goals of a negotiable budget of a department of an organization according to an embodiment of the present invention;

FIG. 21 is a screen view displaying fields to add or edit objectives of a negotiable budget of a department of an organization according to an embodiment of the present invention;

FIG. 22 is a screen view displaying fields to add or edit strategies of a negotiable budget of a department of an organization according to an embodiment of the present invention;

FIG. 23 is a screen view displaying fields to add or edit strategy details of a negotiable budget of a department of an organization according to an embodiment of the present invention;

FIG. 24 is a screen view displaying fields to add or edit requests for strategies of a negotiable budget of a department of an organization according to an embodiment of the present invention;

FIG. 25 is a screen view displaying fields to add or edit request details for strategies of a negotiable budget of a department of an organization according to an embodiment of the present invention;

FIG. 26 is a screen view displaying fields to add or edit committee members or voters of a negotiable budget of a department of an organization according to an embodiment of the present invention;

FIG. 27 is a screen view displaying the table of contents for a series of reports of a department of an organization according to an embodiment of the present invention;

FIG. 28 is a screen view displaying a report of strategies of a department of an organization according to an embodiment of the present invention;

FIG. 29 is a screen view displaying a report of requests for strategies of a department of an organization according to an embodiment of the present invention;

FIG. 30 is a screen view displaying a report of justifications for strategies of a department of an organization according to an embodiment of the present invention;

FIG. 31 is a screen view displaying a report of committee members or voters of a department of an organization according to an embodiment of the present invention;

FIG. 32 is a screen view displaying a report of a department improvement plan of a department of an organization according to an embodiment of the present invention;

FIG. 33 is a screen view displaying a table of contents for setup levels of a department of an organization according to an embodiment of the present invention;

FIG. 34 is a screen view displaying a table of contents for approvals of budget requests for strategies of a department of an organization according to an embodiment of the present invention;

FIG. 35 is a screen view displaying an approval of budget requests for strategies of a department of an organization according to an embodiment of the present invention; and

FIG. 36 is a screen view displaying a voting record of budget requests for strategies of a department of an organization according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

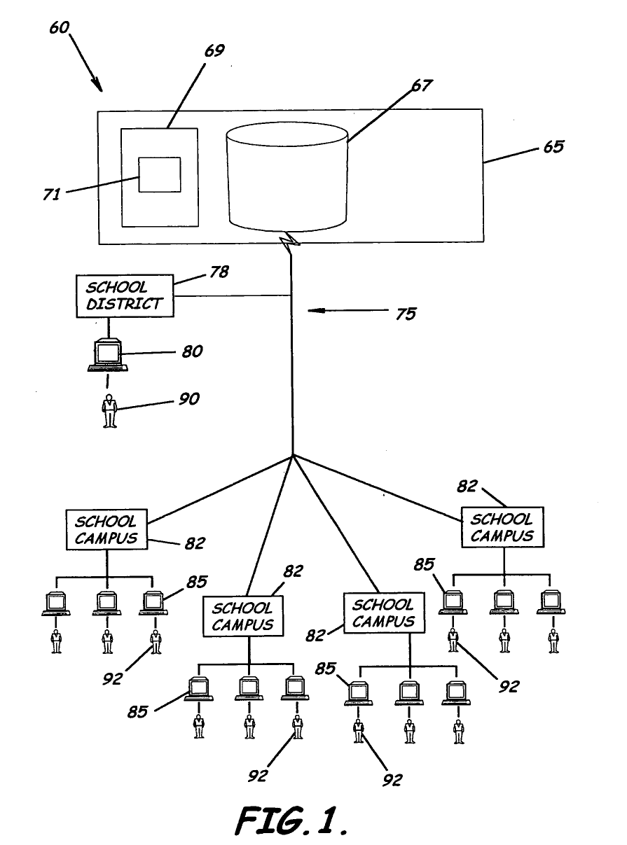

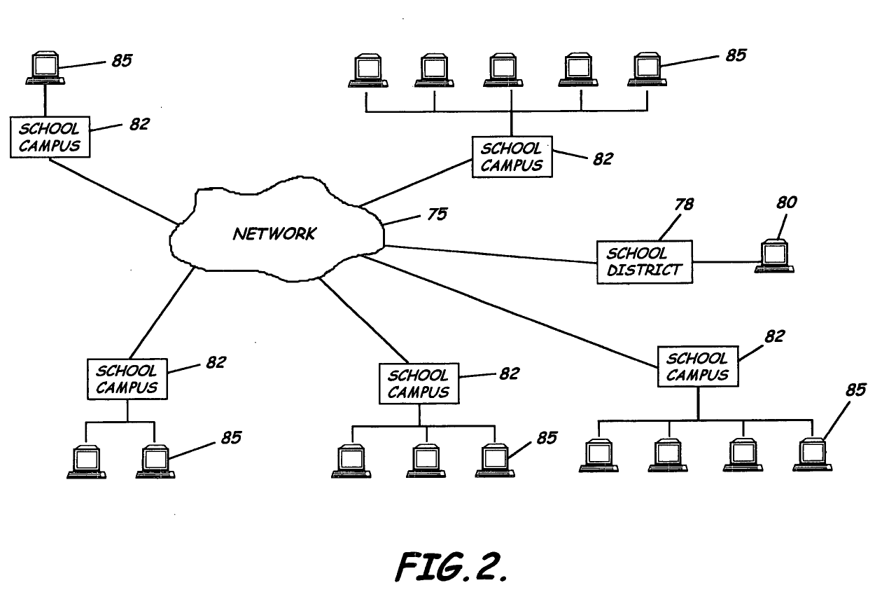

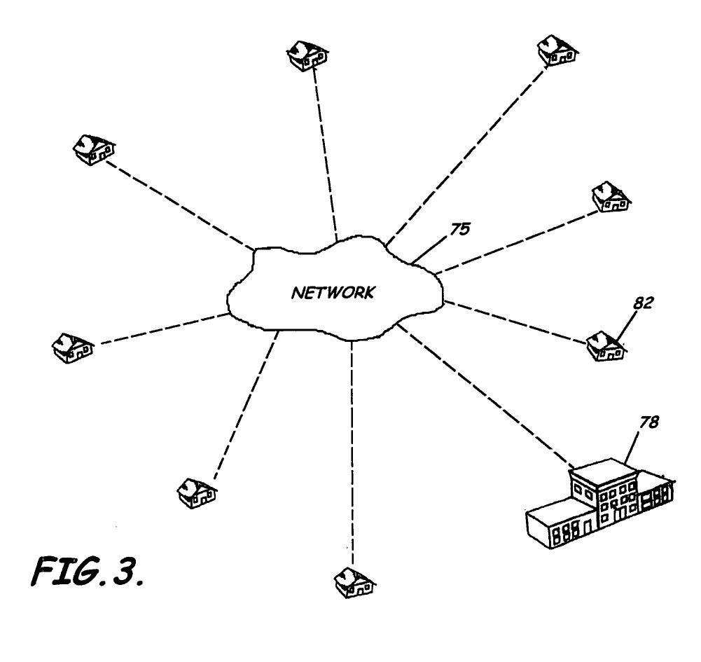

FIGS. 1-3 show a schematic diagram of a system 60 to advantageously enhance financial budgeting for an organization having a number of departments, according to an embodiment of the present invention, which can be arranged and programmed to perform the functionality or method of embodiments of the present invention. As shown, one of the embodiments of the system 60 includes a computer defining a server 65 interfaced with a communication network 75, a plurality of department client computers 85 interfaced with the communication network 75, and a plurality of potential department users 92 interfaced with the department client computers 85. Also, for example, FIGS. 1-3 show an organization client computer 80 interfaced with the communication network 75 and an organization user 90 interfaced with the organization client computer 80. The department client computers 85 and the organization client computer 80 are remote from and in communication with the server 65 through the communication network 75. The server 65 has a database 67 and memory 69 associated therewith. The memory 69 contains a computer program product 71 such as in the form of program code or instruction blocks, as understood by those skilled in the art, to perform some of the features or the functionality of the system 60.

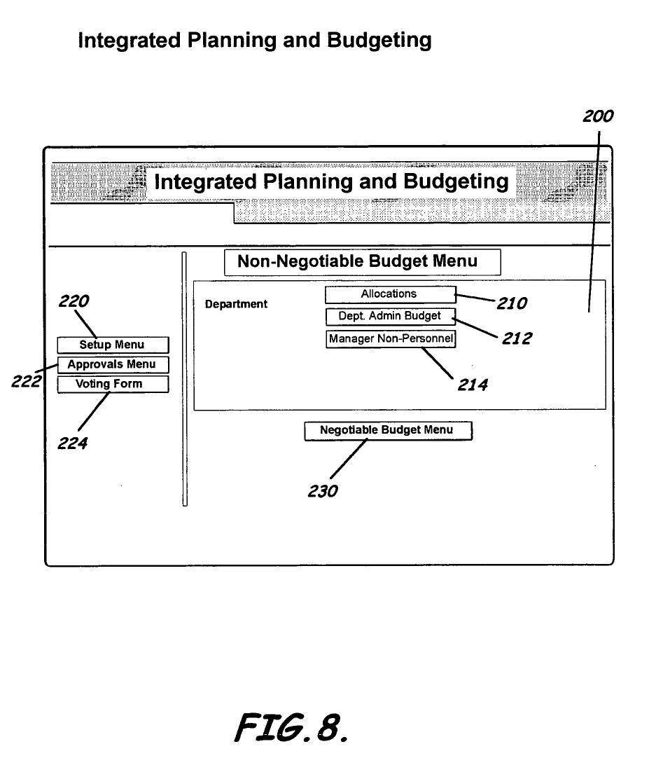

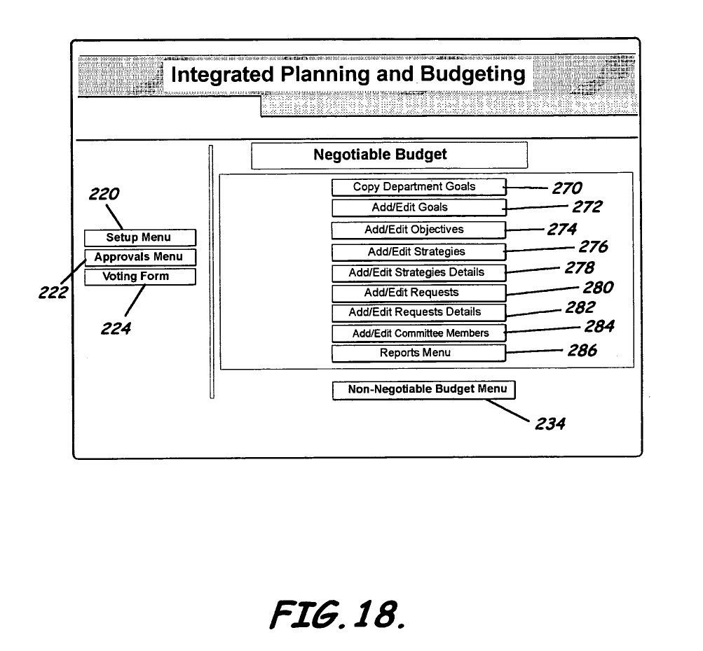

The department users 92 of the department client computers 85 and the organization user 90 of the organization client computer 80 can enter information into the system 60 and view information from the system 60 by selecting from a number of toolbar icons on a toolbar 200 displayed on a graphical user interface (GUI), as understood by those skilled in the art, from the internet/intranet server 65, as shown, for example, in the screen view of FIG. 8 or FIG. 18 or other screen views. As understood by those skilled in the art, the instruction blocks 71 in the memory 69 can provide instructions to implement a graphical user interface with a toolbar 200 having toolbar icons. The instruction blocks 71 also provide instructions to disclose information from the database 67 on the graphical user interface relating to subject matter represented by the specific toolbar icons on the toolbar 200. In addition, the instruction blocks 71 in the memory 69 can provide instructions granting the department users 82 the ability to access the information relating to the specific toolbar icons on the toolbar 200 of the graphical user interface and can also provide instructions enabling the department users 82 to input information into the graphical user interface or modify information existing on the graphical user interface.

The server 65, the department client computers 85, and the organization client computer 80, for example, can be a personal computer, mid-range computer, or a mainframe computer arranged and configured as a server or having server software associated therewith, as understood by those skilled in the art. The server 65, for example, can be a larger computer having more memory and features. The department client computers 85 and organization client computer 80, for example, can be personal computers dispersed in an office environment and in communication with the server 65, for example, through an Internet or Intranet network. Each of the computers 65, 78, 82 can include a hard drive, a display or monitor such as a CRT, LCD, or other monitor screens. The computers 65, 78, 82 can also include a database for storing information and memory in which computer programs may be stored or reside. The computers 65, 78, 82 can also include one or more department user interfaces such as keyboards, mice, data collections, touch-screens, graphical display toolbars and icons, or other devices, as understood by those skilled in the art, with which information and data are transferred between the department users 82 and the system 60. Other output devices may also be included such as printers, facsimile machines, and other such devices as understood by those skilled in the art.

The server 65, each of the department client computers 85, and the organization client computer 80 preferably include a central processing unit (CPU), a read-only memory (ROM), and a random-access memory (RAM), as understood by those skilled in the art. The computers 65, 78, 82, for example, may be a stand-alone system or part of a network such as a local-area-network (LAN) or a wide-area-network (WAN). The server 65, the department client computers 85, and the organization client computer 80, for example, also in alternative embodiments can be interconnected among each other via a global communication network 75 such as the Internet, or a local communication network 75 such as an Intranet that is accessible only within a particular organization 78. Department users 92 may access the server 65 through the department client computers 85 via the communication network 75. Department users 92 may also remotely access the server 65 through a portal having a secure link so the department user 92 can access the server 65 at home or any other location away from the office.

As understood by those skilled in the art, other computer system configurations can also be employed to perform the functionality of the invention, and to the extent that a particular system configuration is capable of performing embodiments of methods of the present invention.

Once the computers are programmed or loaded with software or program product to perform particular functions pursuant to instructions from program software that implements the functionality or method of this invention, such computer systems in effect become special-purpose computers particular to the functionality or method of this invention are as well known to those skilled in the art of computer systems.

In addition, computer programs or program product 71 stored in a tangible computer medium 69 implementing the functionality or method of this invention will commonly be distributed to department users 92 on a distribution medium, such as floppy disk, CD-ROM, or other computer-readable media, for example, as understood by those skilled in the art. The term “computer-readable medium” encompasses distribution media, intermediate storage media, execution memory of a computer, and any other medium or device capable of storing a computer program implementing the functionality or methods of embodiments of the present invention for later reading by a computer system. The computer program will often be copied from the computer-readable medium to a hard disk or a similar intermediate storage medium. When the programs are to be run, they will be loaded either from their distribution medium or their intermediate storage medium into the execution memory of the computer, configuring the computer to act in accordance with the functionality or method of this invention. All such operations are well known to those skilled in the art of computer systems.

As understood by those skilled in the art, various software modules or program product can be used within the computer system in the embodiments of the invention. The department client computers 85 have client software stored thereon that preferably includes software modules such as a client graphical user interface (GUI), a data generator, a data requester, a secure client connector, and a database of information, each of which is understood by those skilled in the art. The data requester requests data from department users 82, and the data generator generates the display on the GUI in which information may be entered about the financial budgeting system. The database is used to store the employee forms and other information regarding the organization 78 and its employees. The department client computer GUI provides a visually pleasing graphical user interface on a monitor to facilitate the input and output of data by department users 82 who are using the client software within the department client computers 85. The secure client connector establishes a private communication session between the department client computers 85 and the server 65, and between the organization client computer 80 and the server.

As also understood by those skilled in the art, the server 65 may include software modules or program product such as a secure server connector, a client confirmer, a security check, a data mover, and a transmission confirmer, as understood by those skilled in the art. The secure server connector allows the department client computers 85 to communicate with the server 65 while keeping the nature of the communications private. The client confirmer and the security component confirm the identity of the department client computers 85, and effectively detect the specific department users 82 accessing the server database 67 at a particular point in time. The data mover receives data from the department client computers 85, and transmits data among the several department client computers 85 and the server 65. The transmission confirmer, for example, can verify that particular information in the database 67 has been transmitted to the several department client computers 85. Embodiments of the invention can also include security measures within the system, for example, to advantageously ensure that each budget manager is capable of viewing and editing only his or her financial budget and planned goals, objectives, and strategies.

As understood by those skilled in the art, the database 67 for embodiments of the system 60, for example, can reside in a web-based intranet server 65. The database 67 within the server 65 may itself comprise several sub-databases, which contain independent blocks of information. For example, one sub-database may include data relating to the budget amounts of money allocated, and another sub-database may include data relating to the strategies or priority rankings thereof. The main database preferably resides within the server 65, but can also be in other ways associated with the server 65 such as by communication with the server 65 via a LAN, via a global communications network such as the Internet, or via a local communications network such as an organization's 78 Intranet. Also, for example, the server 65 can itself include one or more of a plurality of computers, each with a sub-database residing thereon.

The system can also include Microsoft, SAP, and Oracle web-based applications, which can read from each other, as understood by those skilled in the art. The system 60 typically features a search engine for user convenience and a robust security system, as understood by those skilled in the art.

The user interacts with the system 60 through a graphical user interface (GUI), which may feature varying screen views or front plan views displayed on a monitor of a computer. Some screen view images of an embodiment of the invention are illustrated in FIGS. 8-35. The particular features of the GUI screen views depend upon the relative phase of the process being used or implemented by a user.

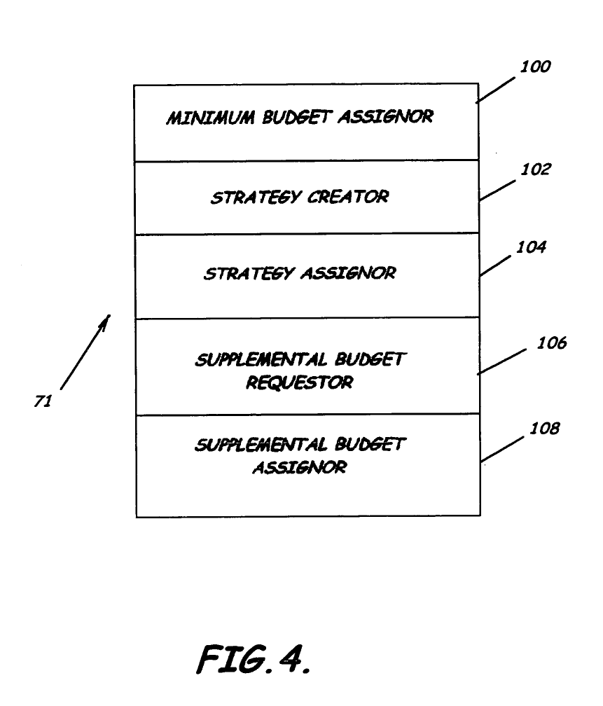

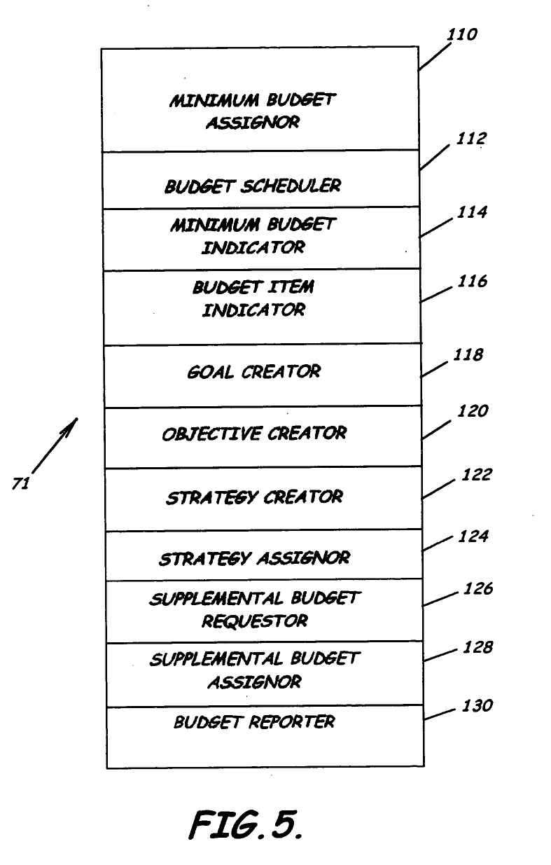

As shown in FIGS. 4-5, for example, program product 71 such as in the form of computer program code instruction blocks is stored in the memory 69 of the server 65 to perform the functionality of the system 60. The instruction blocks represent substantive computer software instructions to perform functionality of system operations. As shown in FIG. 4, for example, an embodiment of the instruction blocks may include a minimum budget assignor 100, 110 which assigns to one of the plurality of departments 82 a minimum budget amount of money determined by the organization 78 so that the department 82 expects to receive at least a minimum amount of money for the fiscal term. The minimum budget assignor 100 is responsive to organization user input commands. The minimum budget amount of money defines a final non-negotiated amount of money allocated from the organization 78 to the department 82 for the fiscal term. As shown in FIG. 8, when the user selects or clicks one of the toolbar icons on the non-negotiable budget toolbar 200, the instruction blocks of the computer program product 71 in the memory 69 instruct the system 60 to show the information relating to that particular icon on the graphical user interface. FIG. 8 shows the non-negotiable budget table of contents of the department 82 of the organization 78. The non-negotiable budget table of contents can include an allocations icon 210, a department administration budget icon 212, and a manager non-personnel budget icon 214, which the user can select at will. The table of contents also includes a setup menu icon 220, an approvals menu icon 222, and a voting form icon 224, which the user can also select at will. Also included at the bottom of the screen is the negotiable budget menu icon 230.

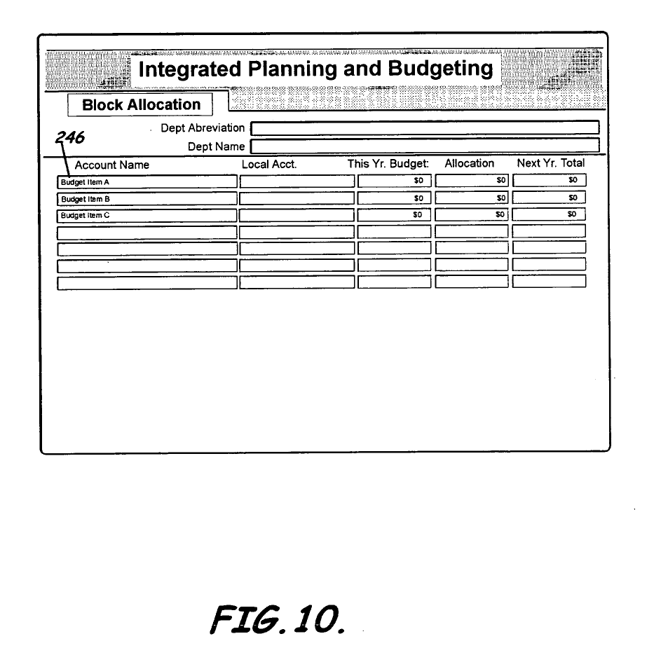

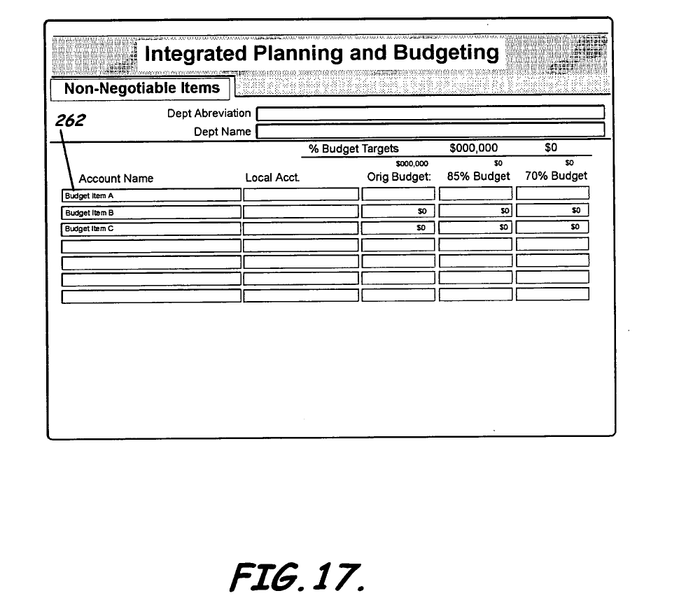

A budget scheduler 112 creates a budget schedule for the fiscal term determined by the school campus 82. The budget scheduler 112 is responsive to department user input commands. The budget schedule defines a plurality of budget items and a budget cost for each of the plurality of budget items. FIG. 10 shows information displaying block allocations of a non-negotiable budget of a department 82 of an organization 78. For example, the information is included within the Department I icon 240, which can include budget items 246 for a particular department 82 of the organization 78. Each budget item 246 shows an account name for the budget item 246 and the budget amounts for the current fiscal term and a future fiscal term. FIG. 17 shows information displaying non-negotiable budget items 262 for a particular department 82 of the organization 78. One embodiment of the non-negotiable budget items 262 displays for each budget item 262 an account name, an original budget, a first percentage budget which in this case is 85%, and a second percentage budget which in this case is 70%. A minimum budget indicator 114 indicates on the budget schedule of the school campus 82 when the sum of the budget costs for the plurality of budget items on the budget schedule exceeds the minimum budget amount of money allocated to the school campus 82 as determined by the school district 78; a budget item indicator 116, responsive to a previous year's budget cost for a particular budget item and the budget scheduler 112 and school campus 82 user input commands, to indicate on the budget schedule of the school campus 82 when the budget cost for the particular budget item exceeds the previous year's budget cost for the particular budget item. The minimum budget indicator is responsive to the minimum budget amount of money and the budget scheduler and school campus user input commands. The budget item indicator is responsive to a previous year's budget cost for a particular budget item and the budget scheduler and school campus user input commands.

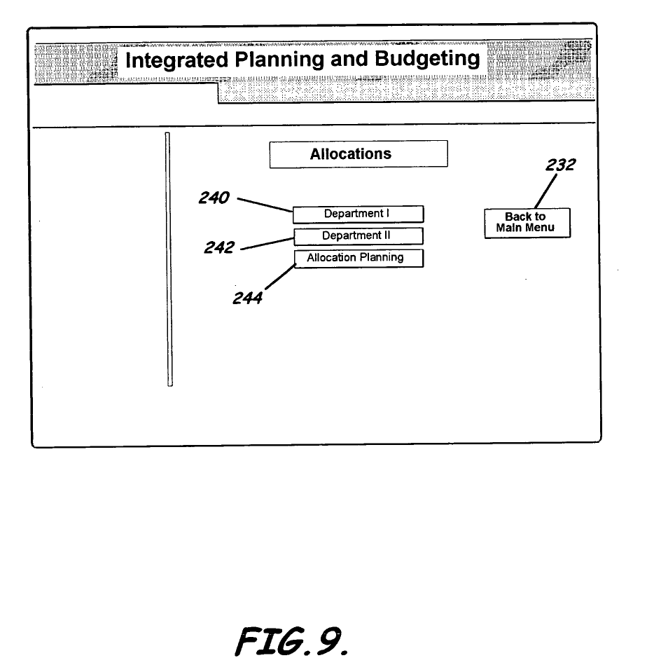

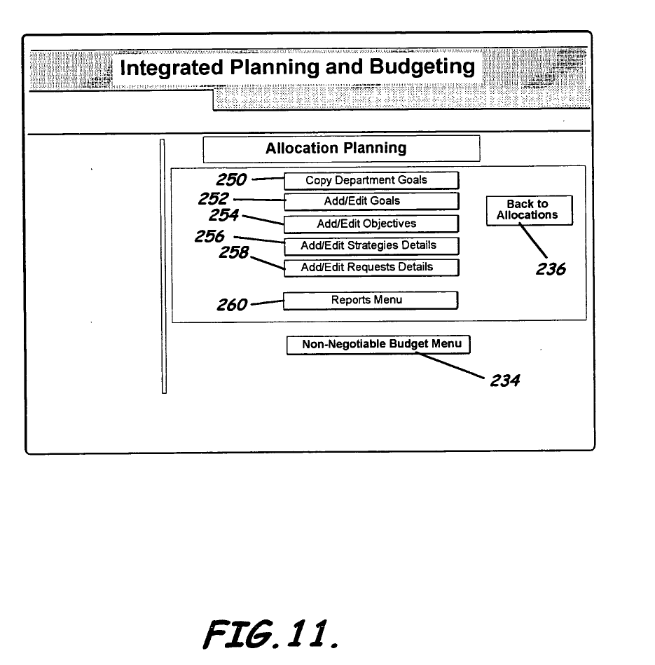

FIG. 9 shows information displaying a table of contents for allocations of a non-negotiable budget of a department 82 of an organization 78. The information is within the allocations icon 210 on the non-negotiable table of contents of the non-negotiable budget toolbar 200 which, for example, can include a Department I icon 240, a Department II icon 242, and an allocation planning icon 244. FIG. 9 also includes a main menu icon 232 to return to the non-negotiable table of contents. FIG. 11 shows information displaying the table of contents for the allocation budget plan of a non-negotiable budget of a department 82 of an organization 78. The information is included within the allocation planning icon 244, which can include a copy department goals icon 250, an add/edit goals icon 252, an add/edit objectives icon 254, an add/edit strategies icon 256, an add/edit requests icon 258, and a reports menu icon 260. Also included is a back to allocations icon 236 redirecting the user back to the allocations icon page, and a non-negotiable budget menu icon 234 redirecting the user back to the table of contents for the non-negotiable budget.

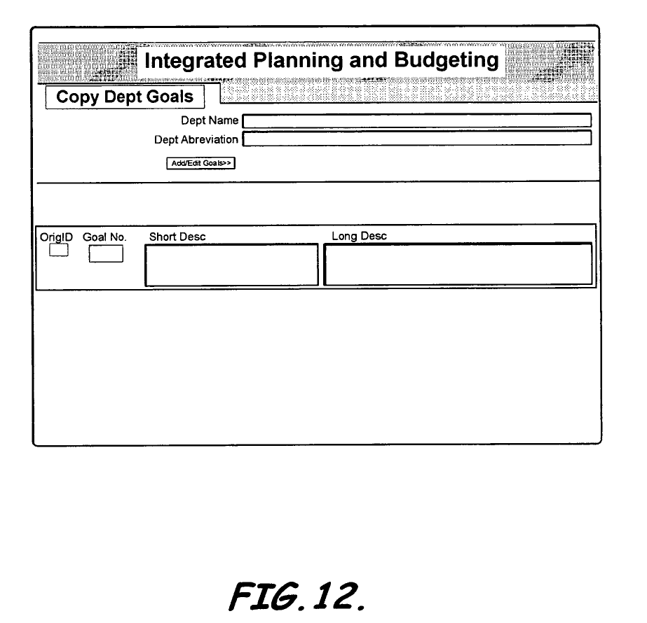

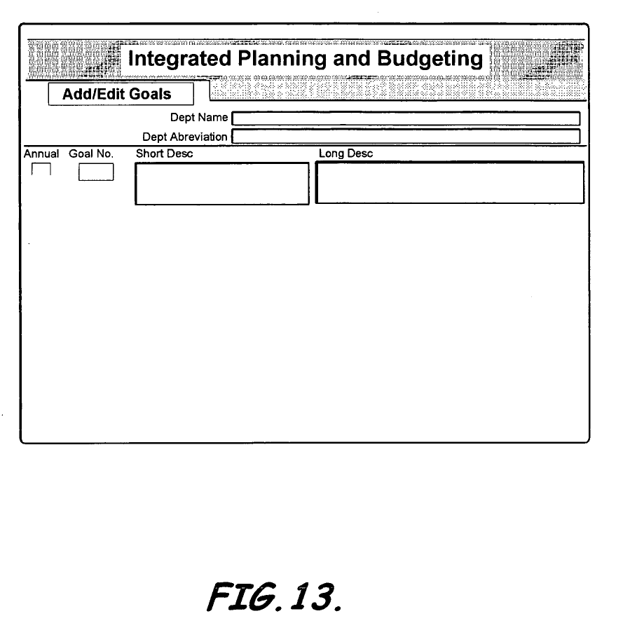

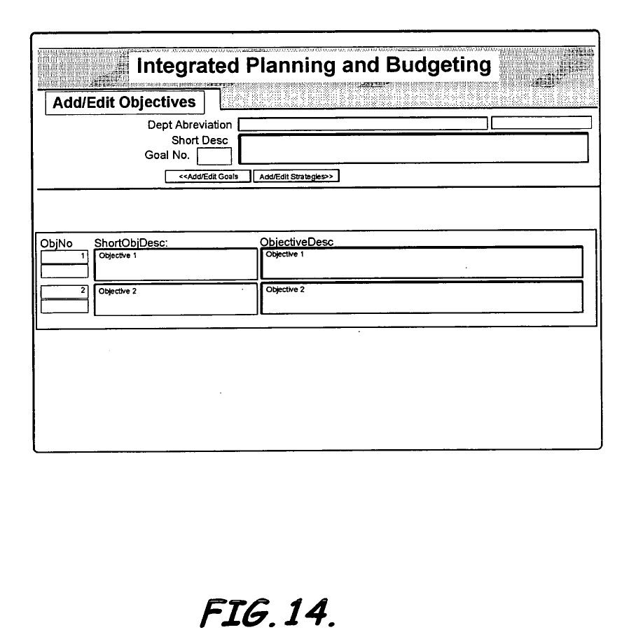

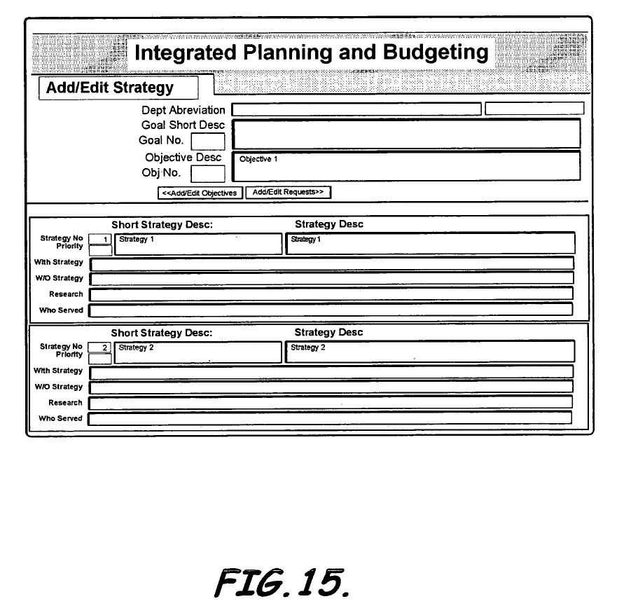

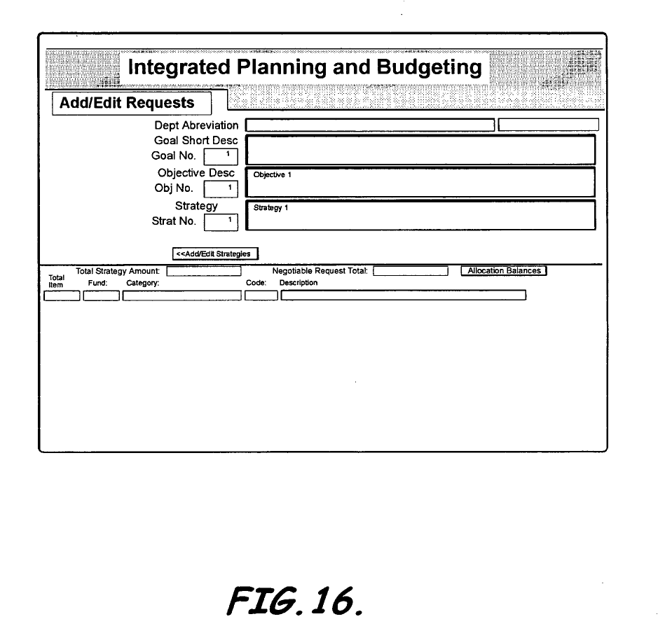

A goal creator 118 creates a plurality of goals for the school campus 82. The goal creator 118 is responsive to school campus 82 user input commands. An objective creator 120 creates a plurality of objectives for each of the plurality of goals. The objective creator 120 is responsive to the plurality of goals and school campus 82 user input commands. A strategy creator 102, 122 creates a plurality of strategies for each of the plurality of objectives of each of the plurality of goals. The strategy creator 102, 122 is responsive to the plurality of goals and the plurality of objectives and school campus 82 user input commands. Iformation within the copy department 82 goals icon 250, shown in FIG. 12, provides the ability to copy department 82 goals to a particular department 82 that may be utilized in other departments 82. Information within the add/edit goals icon 252, shown in FIG. 13, can include information relating to adding or editing goals of a non-negotiable budget of a particular department 82 of the organization 78. Information within the add/edit objectives icon 254, shown in FIG. 14, can include information relating to adding or editing objectives of a non-negotiable budget of a particular department 82 of the organization 78. information within the add/edit strategies icon 256, shown in FIG. 15, can include information relating to adding or editing strategies of a non-negotiable budget of a particular department 82 of the organization 78. Information within the add/edit requests icon 258, shown in FIG. 16, can include information relating to adding or editing requests for strategies of a non-negotiable budget of a particular department 82 of the organization 78.

FIG. 18 shows information displaying the table of contents for a negotiable budget of a department 82 of an organization 78 from the negotiable budget menu icon 230. The negotiable budget table of contents can include a copy organization 78 goals icon 270, an add/edit goals icon 272, an add/edit objectives icon 274, an add/edit strategies icon 276, an add/edit strategies details icon 278, an add/edit requests icon 280, and add/edit requests details icon 282, an add/edit committee members icon 284, and a reports menu icon 286. The table of contents also includes a setup menu icon 220, an approvals menu icon 222, and a voting form icon 224. Also included at the bottom of the screen is the non-negotiable budget menu icon 234.

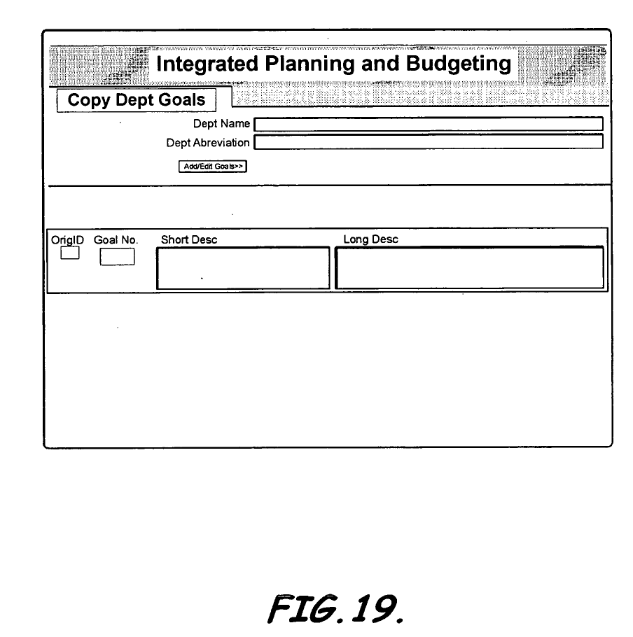

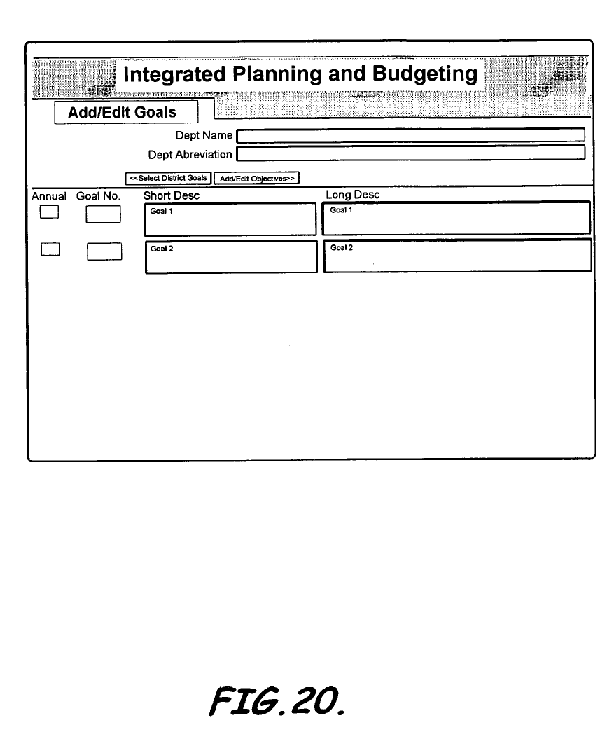

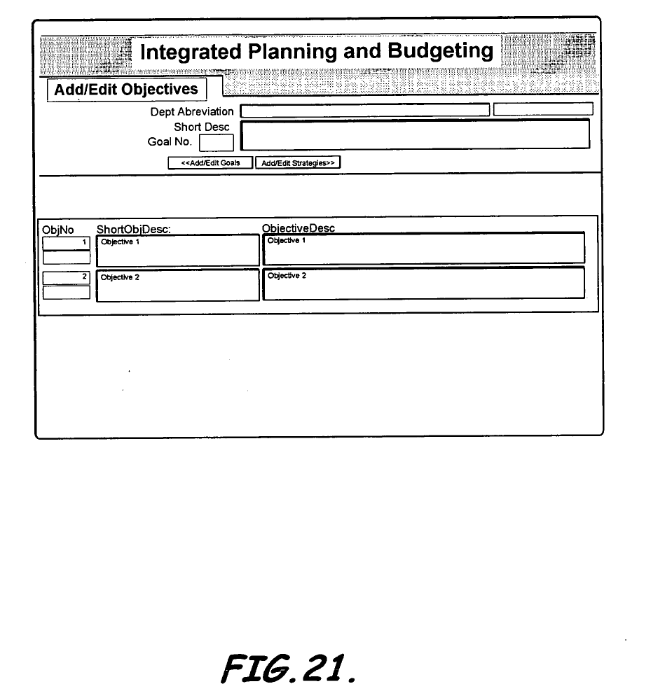

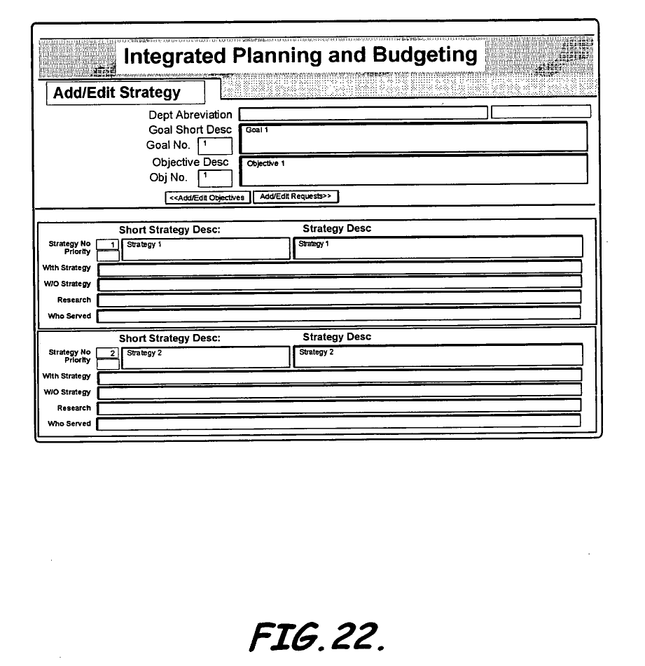

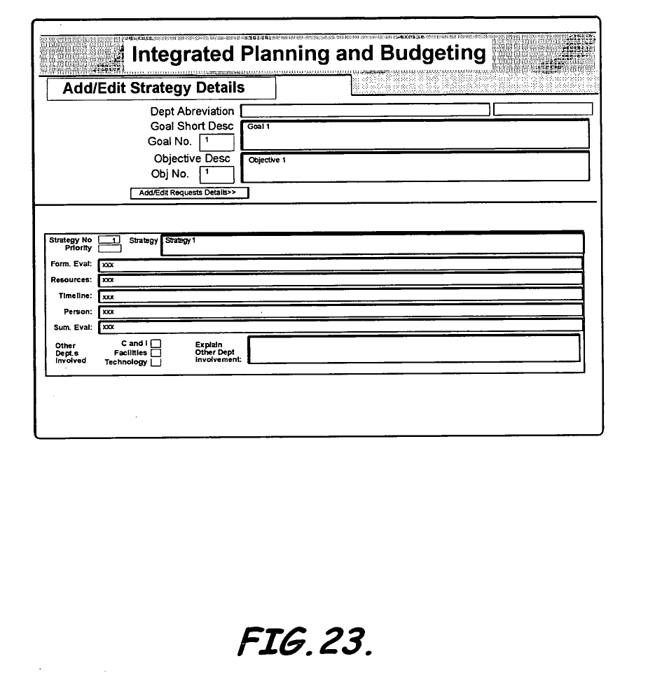

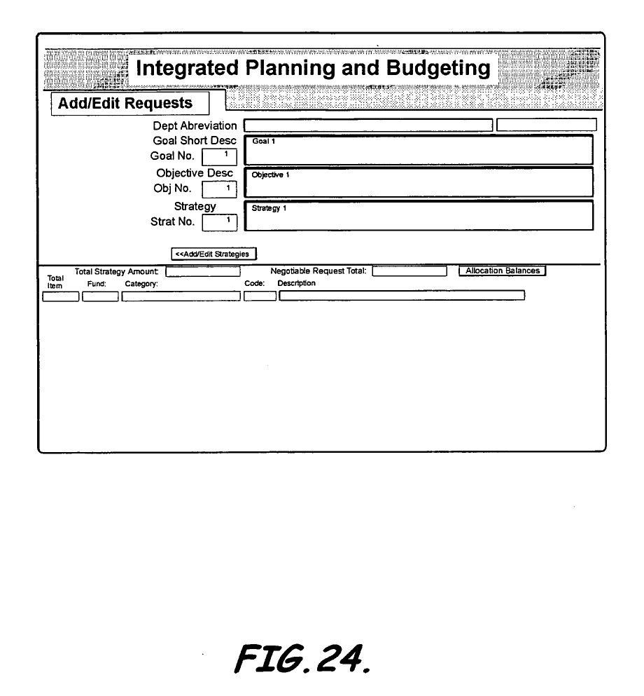

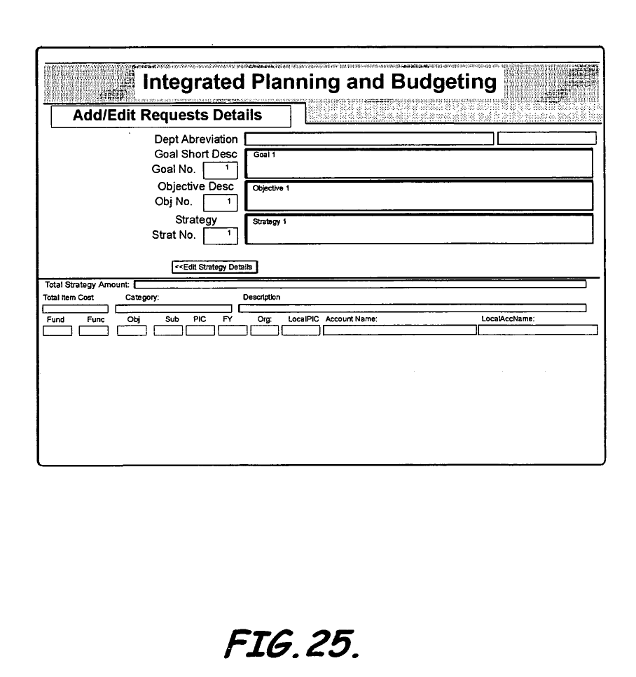

Information within the copy department goals icon 270, shown in FIG. 19, can include information relating to copying goals of a negotiable budget of a particular department 82 of the organization. Information within the add/edit goals icon 272, shown in FIG. 20, can include information relating to adding or editing goals of a negotiable budget of a particular department 82 of the organization 78. Information within the add/edit objectives icon 274, shown in FIG. 21 can include information relating to adding or editing objectives of a negotiable budget of a particular department 82 of the organization 78. Information within the add/edit strategies icon 276, shown in FIG. 22, can include information relating to adding or editing strategies of a negotiable budget of a particular department 82 of the organization 78. Information within the add/edit strategy details icon 278, shown in FIG. 23, can include information relating to adding or editing strategy details of a negotiable budget of a particular department 82 of the organization 78. Information within the add/edit requests icon 280, shown in FIG. 24, can include information relating to adding or editing requests of a negotiable budget of a particular department 82 of the organization 78. Information within the add/edit requests details icon 282, shown in FIG. 25, can include information relating to adding or editing requests details of a negotiable budget of a particular department 82 of the organization 78.

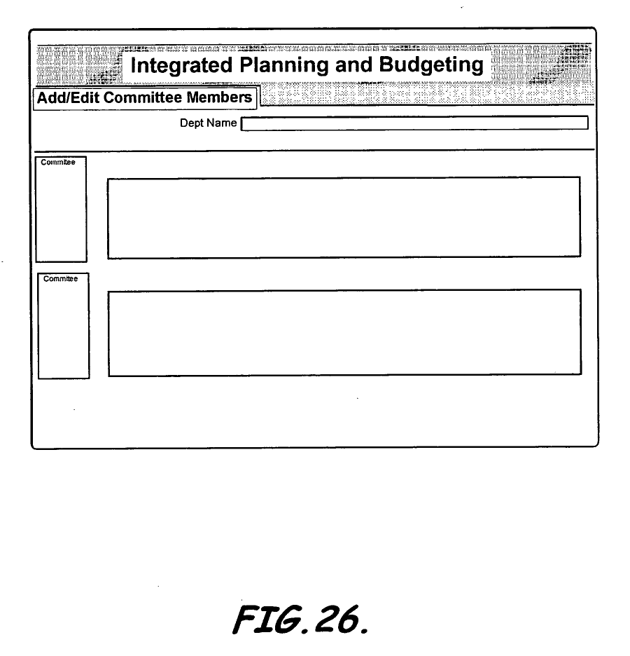

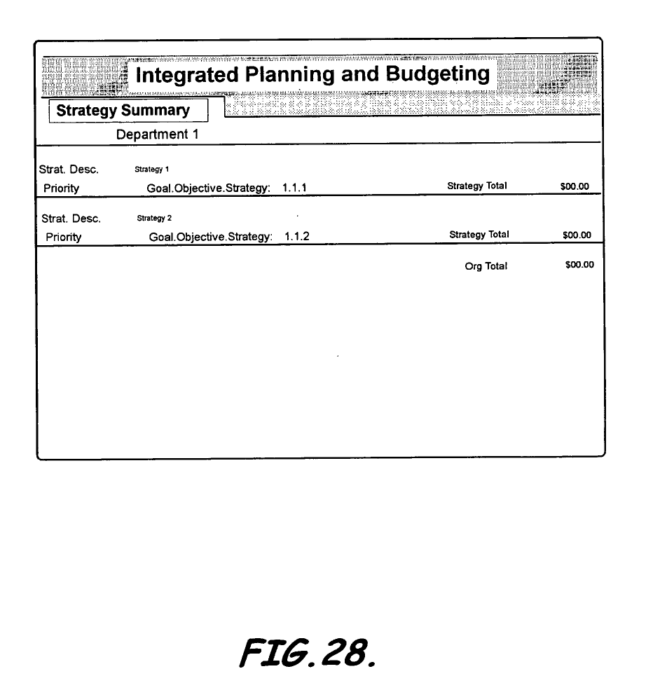

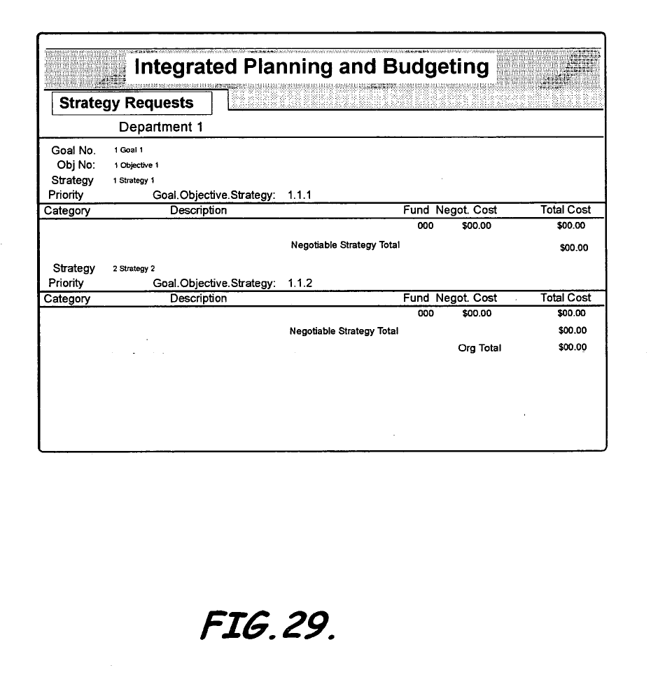

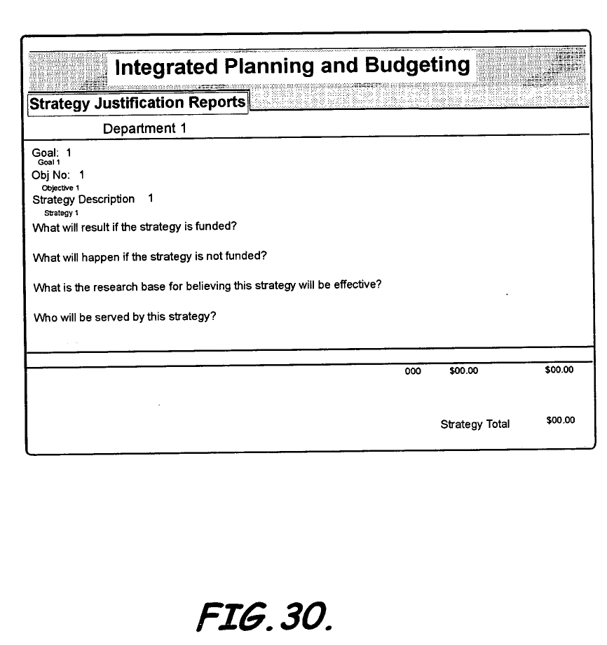

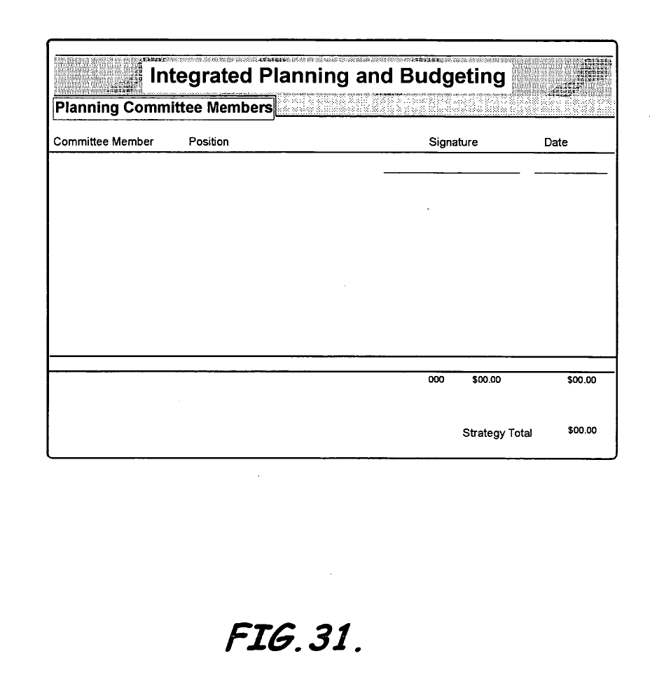

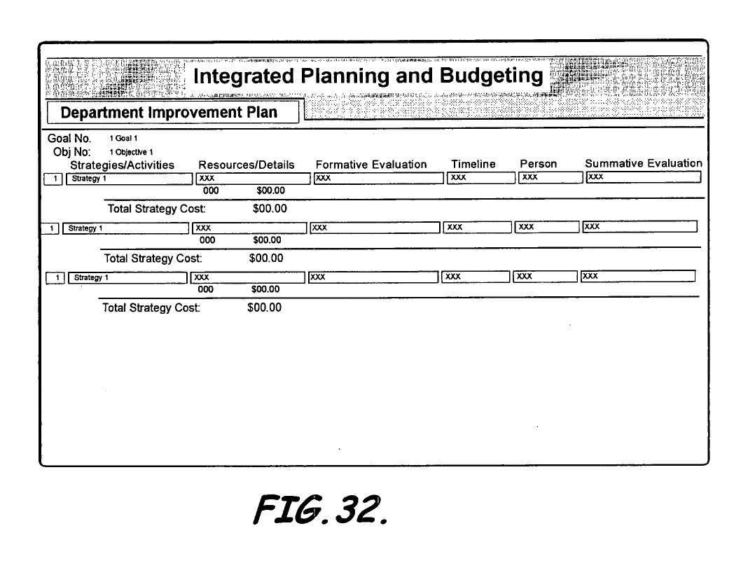

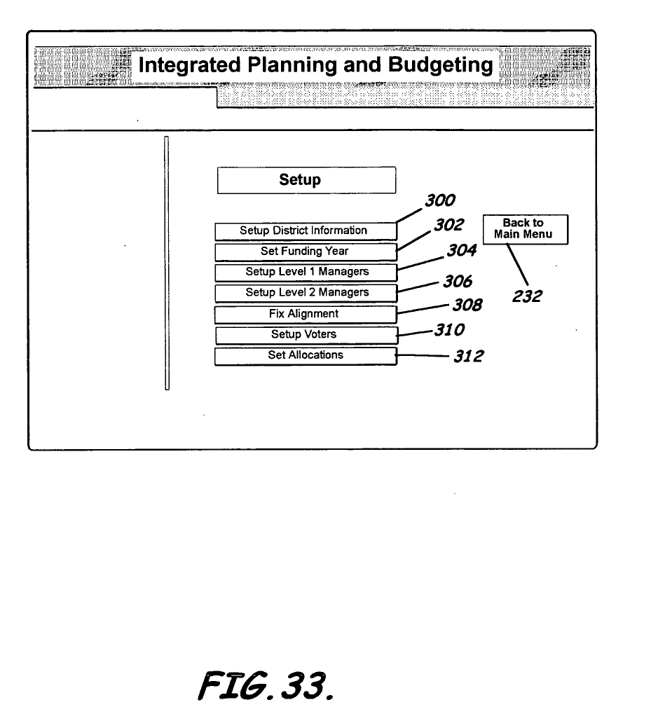

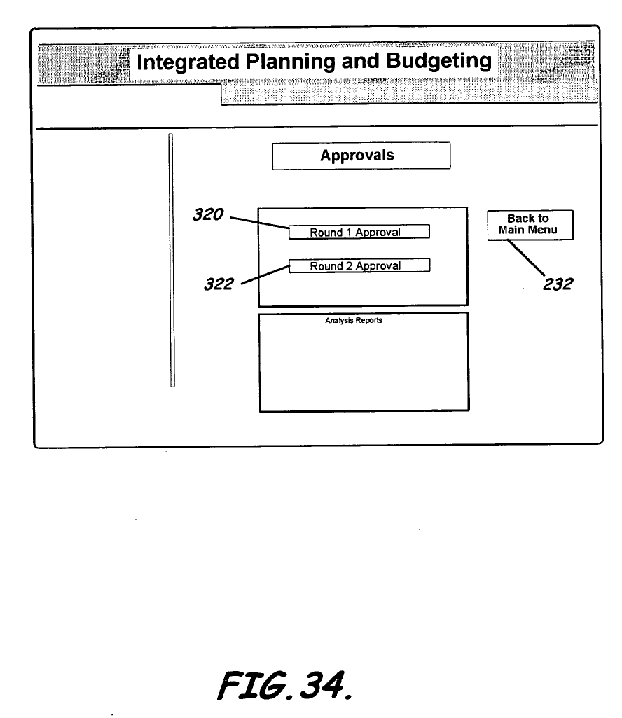

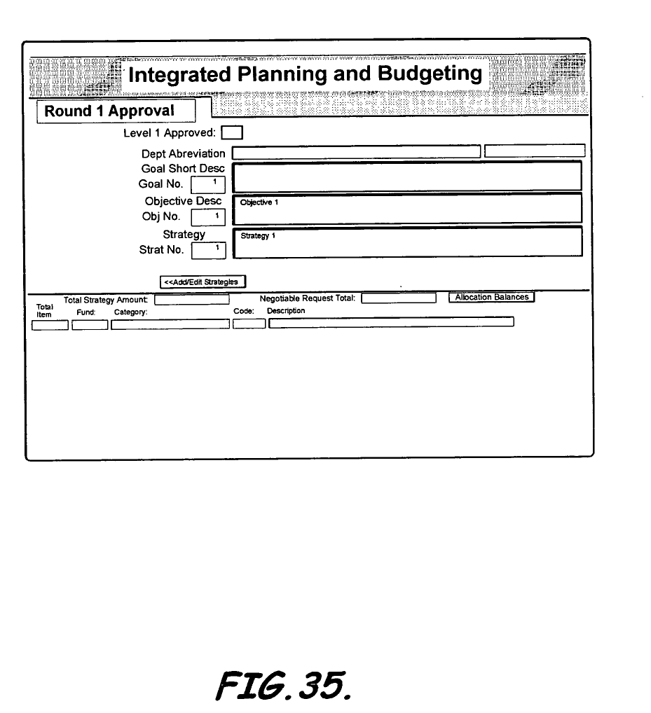

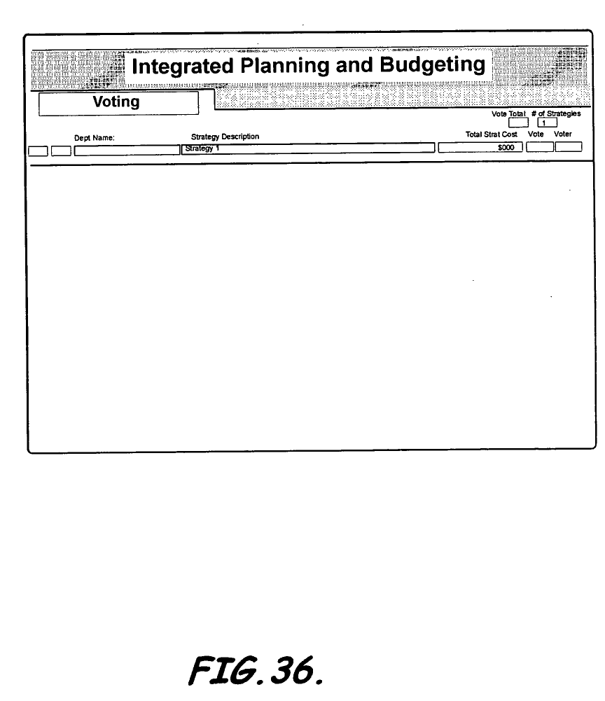

A strategy assignor 104, 124 assigns a priority ranking determined by the department 82 to each of the plurality of strategies to define a plurality of prioritized strategies. Information within the add/edit committee members icon 284, shown in FIG. 26, can include information relating to adding or editing committee members or voters of a negotiable budget of a particular department 82 of the organization 78. The summary strategy icon 290, shown in FIG. 28, can include information relating to the summary of a particular strategy of a department 82 of the organization 78. The strategy requests icon 292, shown in FIG. 29, can include information relating to requests for a particular strategy of a department 82 of the organization 78. The strategy justifications icon 294, shown in FIG. 30, can include information relating to justifications for a particular strategy of a department 82 of the organization 78. The signature page icon 296, shown in FIG. 31, can include a report displaying the signatures of the committee members or voters of a department 82 of the organization 78. Information within the department 82 improvement plan icon 298, shown in FIG. 32, can include information about plans relating to the strategies for a particular department 82 of the organization 78 to improve department 82 initiatives for the future. Information displaying the table of contents for setup levels of a department 82 of the organization 78, shown in FIG. 33 which includes information from within the setup menu icon 220. The table of contents can include a setup organization 78 information icon 300, a setup finding year icon 302, a Setup Level 1 Managers icon 304, a Setup Level 2 Managers icon 306, a setup voters icon 310, and a setup allocations icon 312. The table of contents can also include a main menu icon 232. The table of contents is displayed in FIG. 34 for approvals of a department 82 of the organization 78, which includes information from within the approvals menu icon 222. The table of contents can include a Round 1 Approval icon 320, and a Round 2 Approval icon 322. The table of contents can also include a main menu icon 232. Information within the Round 1 Approval icon 320, shown in FIG. 35, can include information relating to the approval of a particular strategy, objective, or goal of a department 82 of the organization 78. Information within the voting form icon 224, shown in FIG. 36, can include information relating to the voting by the committee members or voters of a department 82 of the organization 78. The voting form can indicate the priority ranking and the total number of votes for a particular strategy of a department 82 of the organization 78.

A supplemental budget requestor 106, 126 submits a plurality of supplemental budget requests for the plurality of prioritized strategies by the school campus 82 to the school district 78 for a requested supplemental amount of money for each of the plurality of supplemental budget requests of the school campus 82 for review and approval by the school district 78. The supplemental budget requestor 106, 126 is responsive to the plurality of prioritized strategies and reasoned justifications and school campus 82 user input commands. The requested supplemental budget amount of money defines a negotiable amount of money independent of the non-negotiable amount of money that is requested from the school district 78 by the school campus 82. A supplemental budget assignor 108, 128 assigns to the school campus 82 a supplemental budget amount of money determined by the school district 78 for at least some of the plurality of prioritized strategies. The supplemental budget assignor 108, 128 is responsive to the supplemental budget request and the plurality of prioritized strategies and school district 78 user input commands. The supplemental budget amount of money defines a final negotiated amount of money independent of the non-negotiable amount of money that is allocated from the school district 78 to the school campus 82 for the fiscal term.

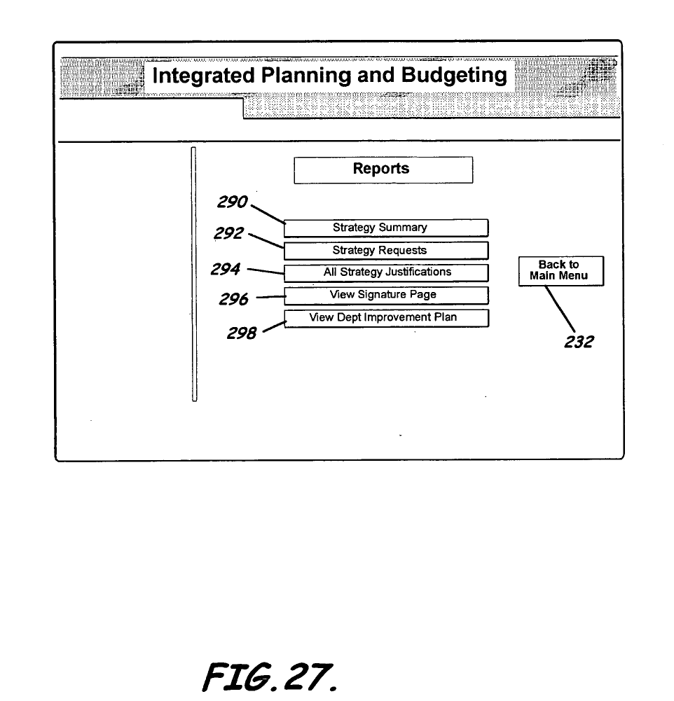

A budget reporter 130 creates a report indicating the final non-negotiated amount of money and the final negotiated amount of money for the fiscal term to thereby inform individuals within the school district 78 and the school campus 82 of the amount of money available for the fiscal term. The budget reporter 130 is responsive to the final non-negotiated amount of money and the final negotiated amount of money. Information displaying the table of contents for a series of reports of a department 82 of an organization 78, as shown in FIG. 27, is within the reports menu icon 286. The table of contents for the reports menu can include a strategy summary icon 290, a strategy requests icon 292, a strategy justifications icon 294, a signature page icon 296, and a department 82 improvement plan icon 298. The table of contents can also include a main menu icon 232.

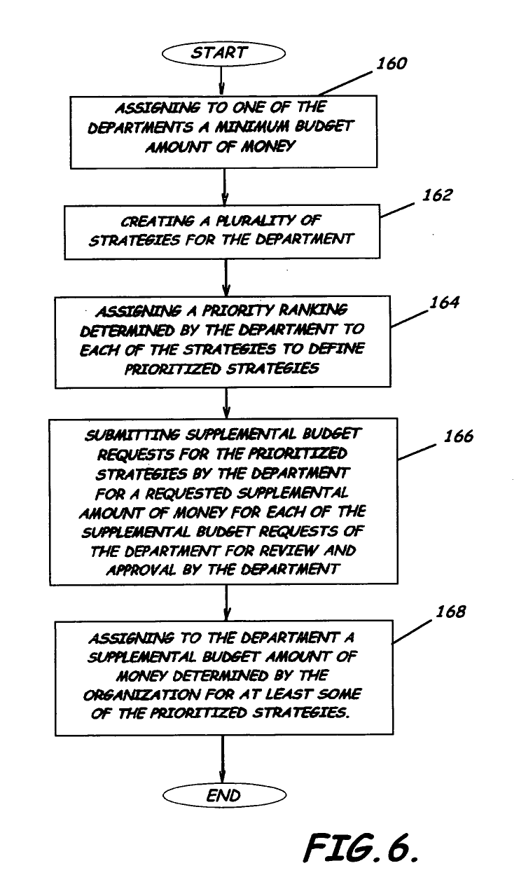

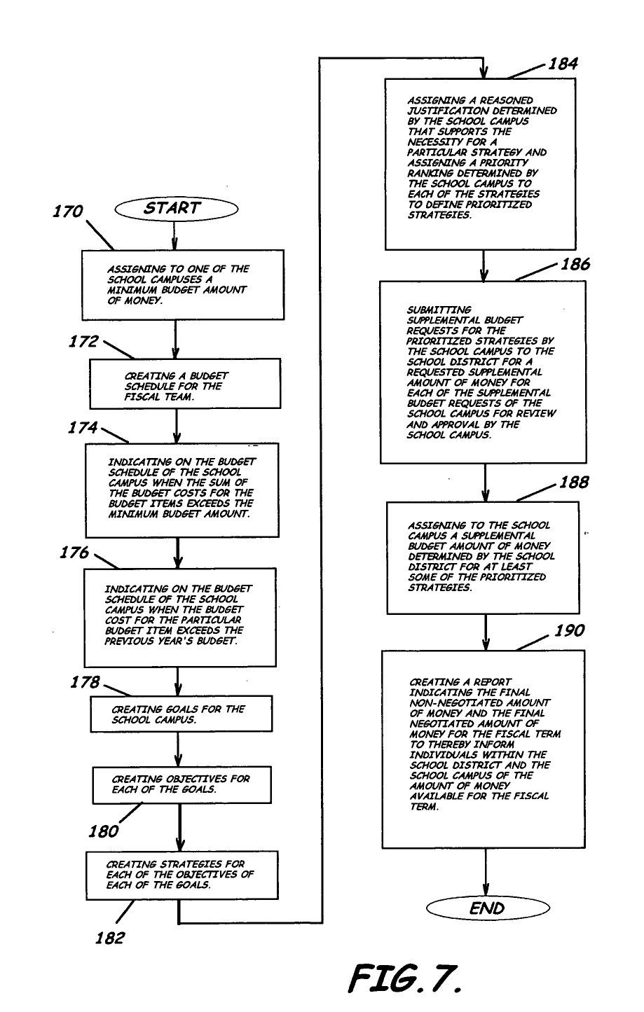

FIGS. 6-7, for example, illustrate the flow or operation of embodiments of the system 60 of the present invention via a flow diagram. As will be understood by those skilled in the art, FIG. 6 illustrates one embodiment of the operation, and FIG. 7 illustrates an alternative embodiment of the operation. The operation may include other alternative embodiments as well which advantageously enhance the financial budgeting of an organization.

FIG. 6, for example, shows an exemplary embodiment of the invention. The process starts with assigning to one of the plurality of departments 82 a minimum budget amount of money determined by the organization 78 so that the department 82 expects to receive at least a minimum amount of money for the fiscal term (see block 160). For example, the minimum budget amount of money might be a sum of money that is substantially guaranteed or for which substantial assurances exist that there would be no major deviations from the minimum budget amount of money. The minimum budget amount of money defines a final non-negotiated amount of money allocated from the organization 78 to the department 82 for the fiscal term.

The process then includes creating a plurality of strategies for the department 82 (see block 162). The process then includes assigning a priority ranking determined by the department 82 to each of the plurality of strategies to define a plurality of prioritized strategies (see block 164). The process then includes submitting a plurality of supplemental budget requests for the plurality of prioritized strategies by the department 82 for a requested supplemental amount of money for each of the plurality of supplemental budget requests of the department 82 for review and approval by the organization 78 (see block 166). The requested supplemental budget amount of money defines a negotiable amount of money independent of the non-negotiable amount of money that is requested from the organization 78 by the department 82. The process then includes assigning to the department 82 a supplemental budget amount of money determined by the organization 78 for at least some of the plurality of prioritized strategies (see block 168). The supplemental budget amount of money defines a final negotiated amount of money independent of the non-negotiable amount of money that is allocated from the organization 78 to the department 82 for the fiscal term.

FIG. 7 shows another exemplary embodiment of the invention. The process starts with assigning to one of the plurality of school campuses 82 a minimum budget amount of money determined by the school district 78 so that the school campus 82 expects to receive at least a minimum amount of money for the fiscal term (see block 170). For example, the minimum budget amount of money might be a sum of money that is substantially guaranteed or for which substantial assurances exist that there would be no major deviations from the minimum budget amount of money. The minimum budget amount of money defines a final non-negotiated amount of money allocated from the school district 78 to the school campus 82 for the fiscal term.

The process then includes creating a budget schedule for the fiscal term determined by the school campus 82 (see block 172). The budget schedule defines a plurality of budget items and a budget cost for each of the plurality of budget items. The process then includes indicating on the budget schedule of the school campus 82 when the sum of the budget costs for the plurality of budget items on the budget schedule exceeds the minimum budget amount of money allocated to the school campus 82 as determined by the school district 78 (see block 174). The minimum budget amount of money typically defines a selected percentage amount of a previous year's budget for the school campus 82. The process then includes indicating on the budget schedule of the school campus 82 when the budget cost for the particular budget item exceeds the previous year's budget cost for the particular budget item (see block 176).

The process then includes creating a plurality of goals for the school campus 82 (see block 178), and also creating a plurality of objectives for each of the plurality of goals (see block 180). The process then includes creating a plurality of strategies for the school campus 82 (see block 182). The strategies created correspond to each of the plurality of objectives of each of the plurality of goals. The process then includes assigning a priority ranking determined by the school campus 82 to each of the plurality of strategies to define a plurality of prioritized strategies (see block 184).

The process then includes submitting a plurality of supplemental budget requests for the plurality of prioritized strategies by the school campus 82 for a requested supplemental amount of money for each of the plurality of supplemental budget requests of the school campus 82 for review and approval by the school district 78 (see block 186). The requested supplemental budget amount of money defines a negotiable amount of money independent of the non-negotiable amount of money that is requested from the school district 78 by the school campus 82. The process then includes assigning to the school campus 82 a supplemental budget amount of money determined by the school district 78 for at least some of the plurality of prioritized strategies (see block 188). The supplemental budget amount of money defines a final negotiated amount of money independent of the non-negotiable amount of money that is allocated from the school district 78 to the school campus 82 for the fiscal term. The process then includes creating a report indicating the final non-negotiated amount of money and the final negotiated amount of money for the fiscal term to thereby inform individuals within the school district 78 and the school campus 82 of the amount of money available for the fiscal term (see block 190).

As illustrated in FIGS. 1-7, and as described herein, embodiments of the present invention include a computer program product 71 embodied in a computer-readable medium 69 to enhance financial budgeting of an organization 78 having a plurality of departments 82. An embodiment of a computer program product 71 includes instructions that perform the functionality of the system operations.

This embodiment of a computer program product 71 can include instructions wherein the organization 78 comprises a school district 78 and the plurality of departments 82 comprise a plurality of school campuses 82.

This embodiment of a computer program product 71 can further include instructions where the strategy assignor 104, 124 assigns a reasoned justification determined by the department 82 that supports the necessity for a particular strategy to each of the plurality of strategies. The priority ranking assigned by the strategy assignor 104, 124 to each of the plurality of strategies is based upon the reasoned justification. The strategy assignor 104, 124 further assigns priority rankings to each of the plurality of strategies by having each of a plurality of voters selected by the department 82 assign a numerical value in a preselected range of values to each of the plurality of strategies. Each of the voters comprises one or more individuals selected by the department 82. A vote valuator defines the preselected range of values as being values of zero, one, and two. The vote valuator is responsive to the strategy assignor. A vote assignor assigns a value of zero to the particular strategy for each of the plurality of voters that regards the particular strategy as unimportant, assigns a value of one to the particular strategy for each of the plurality of voters that regards the particular strategy as moderately important, assigns a value of two to the particular strategy for each of the plurality of voters that regards the particular strategy as very important, determines the sum of each of the values assigned to the particular strategy by each of the plurality of voters to define a total priority value for the particular strategy, and assigns a particular priority ranking to the particular strategy responsive to comparing the total priority value for the particular strategy with total priority values for other strategies of the department 82. The vote assignor is responsive to a particular strategy and each of the plurality of voters representing the department 82. A strategy submitter submits the reasoned justifications and prioritized strategies for the plurality of strategies by the department 82 to the organization 78. The strategy submitter is responsive to the plurality of prioritized strategies and reasoned justifications and department users 82 input commands.

Embodiments of a computer program product 71 can also include a transmitter that reports information to an agency such as a governmental agency. The goal transmitter transmits the plurality of goals to a governmental agency to fulfill legal obligations related to submission of department 82 goals. The goal transmitter is responsive to the goal creator 118. An objective transmitter transmits the plurality of objectives to a governmental agency to fulfill legal obligations related to submission of department 82 objectives. The objective transmitter is responsive to the objective creator 120. A strategy transmitter transmits the plurality of strategies to a governmental agency to fulfill legal obligations related to submission of department 82 strategies. The strategy transmitter is responsive to the strategy creator 102, 122.

As also illustrated in FIGS. 1-7, and as described herein, the present invention also provides methods to enhance financial budgeting of an organization 78 having a plurality of departments 82 for a preselected future fiscal term to thereby integrate financial budgeting with strategic planning.

Embodiments of the method can also include the organization 78 comprising a school district 78 and the plurality of departments 82 comprising a plurality of school campuses 82.

Embodiments of the method can further define the step of assigning priority rankings to include assigning a reasoned justification determined by the department 82 that supports the necessity for a particular strategy to each of the plurality of strategies. The priority ranking assigned by the strategy assignor 104, 124 to each of the plurality of strategies is based upon the reasoned justification (see block 184). The method can include assigning priority rankings to each of the plurality of strategies by having each of a plurality of voters selected by the department 82 assign a numerical value in a preselected range of values to each of the plurality of strategies. Each of the plurality of voters comprises one or more individuals selected by the school campus 82. The method can include defining the preselected range of values as being values of zero, one, and two. The method can include assigning a value of zero to the particular strategy for each of the plurality of voters that regards the particular strategy as unimportant, assigning a value of one to the particular strategy for each of the plurality of voters that regards the particular strategy as moderately important, and assigning a value of two to the particular strategy for each of the plurality of voters that regards the particular strategy as very important. The method can include determining the sum of each of the values assigned to the particular strategy by each of the plurality of voters to define a total priority value for the particular strategy. The method can include assigning a particular priority ranking to the particular strategy responsive to comparing the total priority value for the particular strategy with total priority values for other strategies of the department 82. The method can include submitting by the department 82 the reasoned justifications and prioritized strategies for the plurality of strategies to the organization 78.

Embodiments of the method can also include transmitting the plurality of goals to a governmental agency to fulfill legal obligations related to submission of department 82 goals. The method can include transmitting the plurality of objectives to a governmental agency to fulfill legal obligations related to submission of department 82 objectives. The method can include transmitting the plurality of strategies to a governmental agency to fulfill legal obligations related to submission of department 82 strategies.

Still further embodiments of the present invention can include a computer memory element 69 containing stored in signal bearing media a database. The database contains the data in computer-readable format. The database can contain data indicating an organizational structure, including data indicating an organization 78 having a plurality of departments 82. The database can contain data indicating minimum budget allocation information for a preselected future fiscal term, including data indicating a minimum budget amount of money determined by the organization 78 that the department 82 is guaranteed for the fiscal term. The minimum budget amount of money defines a final non-negotiated amount of money allocated from the organization 78 to the department 82 for the fiscal term (see blocks 160, 170). The database can contain data indicating a plurality of strategies (see blocks 162, 182). The database can contain data indicating each strategy having a priority ranking determined by the department 82 to define a plurality of prioritized strategies (see blocks 164, 184). The database can contain data indicating supplemental budget request information for the fiscal term, including data indicating a plurality of supplemental budget requests for the plurality of prioritized strategies by the department 82 for a requested supplemental amount of money for each of the plurality of supplemental budget requests of the department 82 for review and approval by the organization 78. The requested supplemental budget amount of money defines a negotiable amount of money independent of the non-negotiable amount of money that is requested from the organization 78 by the department 82 (see blocks 166, 186). The database can contain data indicating supplemental budget allocation information for the fiscal term, including data indicating a supplemental budget amount of money determined by the organization 78 that is allocated to the department 82 for at least some of the plurality of prioritized strategies, the supplemental budget amount of money defining a final negotiated amount of money independent of the non-negotiable amount of money that is allocated from the organization 78 to the department 82 for the fiscal term (see blocks 168, 188).

An embodiment of a computer memory element 104 can include a database further containing data indicating a reasoned justification determined by the department 82 for each of the plurality of strategies that supports the necessity for a particular strategy, in which the priority ranking of each of the plurality of strategies is based upon the reasoned justification (see block 184).

An embodiment of a computer memory element 104 can include a database further containing data indicating a report indicating the final non-negotiated amount of money and the final negotiated amount of money for the fiscal term (see block 190).

Embodiments of the present invention include many advantages, benefits, and features, including enhancing the financial budgeting of an organization 78 or school district 78 having many departments 82 or school campuses 82. Embodiments of the invention, for example, can guarantee the school campus 82 a minimum budget amount of money for the fiscal term, typically as a percentage of the previous year's budget for the particular school campus 82, as determined by the school district 78. Further, for example, embodiments can advantageously indicate on the budget schedule of the school campus 82 when the sum of the budget costs for the plurality of budget items on the budget schedule exceed the minimum budget amount of money allocated to the school campus 82 as determined by the school district 78. Further, for example, embodiments can advantageously indicate on the budget schedule of the school campus 82 when the budget cost for any particular budget item exceeds the previous year's budget cost for the particular budget item.

Embodiments include other important benefits and features, including the ability to advantageously assign priority rankings to each of a number of strategies of the school campus 82 based upon reasoned justifications, as determined by the school district 78. Embodiments can advantageously assign to the school campus 82 a supplemental budget amount of money determined by the school district 78 for the prioritized strategies as the school district 78 sees fit. Embodiments can additionally advantageously assign the priority rankings by having a number of voters selected by the school campus 82 assign a numerical value in a preselected range of values (for example the values 0, 1, and 2) to each of the strategies, and then determining the sum of the values assigned to each strategy. The priority ranking is advantageously derived from comparing the sum total for each strategy of the school campus 82 with the sum total for the other strategies of the school campus 82. The priority ranking is ultimately submitted by the school campus 82 to the school district 78 for review as part of the process of deciding the relative negotiable supplemental budget amounts of money allocated to each strategy of each school campus 82 within the school district 78.

Some embodiments also, for example, can include benefits and features that can devise a report indicating the final non-negotiated minimum budget amount of money and the final negotiated supplemental budget amount of money for the fiscal term. In addition, embodiments can also transmit a report of a number of goals, objectives, and strategies for the school campus 82 to a governmental agency to fulfill legal obligations related to submission of school campus 82 goals, objectives, and strategies.

In the drawings and specification, there have been disclosed embodiments of the present invention, and although specific terms are employed, the terms are used in a descriptive sense only and not for purposes of limitation, the scope of the invention being set forth in the following claims. The invention has been described in considerable detail with specific reference to the illustrated embodiments. It will be apparent, however, that various modifications and changes can be made within the spirit and scope of the invention as described in the foregoing specification.

That claimed is:

1. A system to enhance financial budgeting of a school district having a plurality of school campuses for a preselected future fiscal term to thereby integrate financial budgeting with strategic planning, the system comprising:
a computer defining a server and having a database and memory associated therewith, the server adapted to interface with a communication network;
a school district administrative computer adapted to interface with the communication network and a school district user, the school district administrative computer being remote from and in communication with the server through the communication network;
a plurality of school campus client computers each adapted to interface with the communication network and a school campus user, each of the plurality of school campus client computers being remote from and in communication with the server through the communication network; and
a program product stored in the memory of the server and adapted to be accessible by the school district administrative computer and the school campus client computers, the program product having instructions comprising:
(a) a minimum budget assignor, responsive to school district user input commands, to assign to one of the plurality of school campuses a minimum budget amount of money determined by the school district so that the school campus expects to receive at least a minimum amount of money for the fiscal term, the minimum budget amount of money defining a final non-negotiated amount of money allocated from the school district to the school campus for the fiscal term,
(b) a budget scheduler, responsive to school campus user input commands, to create a budget schedule for the fiscal term determined by the school campus, the budget schedule defining a plurality of budget items and a budget cost for each of the plurality of budget items,
(c) a minimum budget indicator, responsive to the minimum budget amount of money and the budget scheduler and school campus user input commands, to indicate on the budget schedule of the school campus when the sum of the budget costs for the plurality of budget items on the budget schedule exceeds the minimum budget amount of money allocated to the school campus as determined by the school district,
(d) a budget item indicator, responsive to a previous year's budget cost for a particular budget item and the budget scheduler and school campus user input commands, to indicate on the budget schedule of the school campus when the budget cost for the particular budget item exceeds the previous year's budget cost for the particular budget item,
(e) a goal creator, responsive to school campus user input commands, to create a plurality of goals for the school campus,
(f) an objective creator, responsive to the plurality of goals and school campus user input commands, to create a plurality of objectives for each of the plurality of goals,
(g) a strategy creator, responsive to the plurality of goals and the plurality of objectives and school campus user input commands, to create a plurality of strategies for each of the plurality of objectives of each of the plurality of goals,
(h) a strategy assignor, responsive to the plurality of strategies and school campus user input commands, to assign a reasoned justification determined by the school campus that supports the necessity for a particular strategy to each of the plurality of strategies, and to assign a priority ranking determined by the school campus to each of the plurality of strategies based upon the reasoned justification to define a plurality of prioritized strategies,
(i) a supplemental budget requester, responsive to the plurality of prioritized strategies and reasoned justifications and school campus user input commands, to submit a plurality of supplemental budget requests for the plurality of prioritized strategies by the school campus to the school district for a requested supplemental amount of money for each of the plurality of supplemental budget requests of the school campus for review and approval by the school district, the requested supplemental budget amount of money defining a negotiable amount of money independent of the non-negotiable amount of money that is requested from the school district by the school campus,
(j) a supplemental budget assignor, responsive to the supplemental budget request and the plurality of prioritized strategies and school district user input commands, to assign to the school campus a supplemental budget amount of money determined by the school district for at least some of the plurality of prioritized strategies, the supplemental budget amount of money defining a final negotiated amount of money independent of the non-negotiable amount of money that is allocated from the school district to the school campus for the fiscal term, and
(k) a budget reporter, responsive to the final non-negotiated amount of money and the final negotiated amount of money, to create a report indicating the final non-negotiated amount of money and the final negotiated amount of money for the fiscal term to thereby inform individuals within the school district and the school campus of the amount of money available for the fiscal term.

2. A system as defined in claim 1, wherein the minimum budget amount of money comprises a selected percentage amount of a previous year's budget for the school campus.

3. A system as defined in claim 1, wherein the program product has instructions further comprising:
a strategy submitter, responsive to the plurality of prioritized strategies and reasoned justifications and school campus user input commands, to submit by the school campus the reasoned justifications and prioritized strategies for the plurality of strategies to the school district.

4. A system as defined in claim 1, wherein the strategy assignor further comprises instructions to assign priority rankings to each of the plurality of strategies by having each of a plurality of voters selected by the school campus assign a numerical value in a preselected range of values to each of the plurality of strategies, wherein each of the plurality of voters comprises one or more individuals selected by the school campus.

5. A system as defined in claim 4, wherein the program product has instructions further comprising:
a vote valuator, responsive to the strategy assignor, to define the preselected range of values as being values of zero, one, and two;
a vote assignor, responsive to a particular strategy and the voters, to assign a value of zero to the particular strategy for each of the plurality of voters that regards the particular strategy as unimportant, to assign a value of one to the particular strategy for each of the plurality of voters that regards the particular strategy as moderately important, to assign a value of two to the particular strategy for each of the plurality of voters that regards the particular strategy as very important, to determine the sum of each of the values assigned to the particular strategy by each of the plurality of voters to define a total priority value for the particular strategy, and to assign a particular priority ranking to the particular strategy responsive to comparing the total priority value for the particular strategy with total priority values for other strategies of the school campus.

6. A system as defined in claim 1, wherein the program product has instructions further comprising:
a goal storer, responsive to user input commands, to create a goal depository and to assign a plurality of preselected goals to the goal depository for storage in the goal depository; and
a goal accessor, responsive to user input commands, to access at least one of the plurality of goals from the goal depository and to assign the goal to the school campus.

7. A system as defined in claim 1, wherein the program product has instructions further comprising:
a goal transmitter, responsive to the goal creator, to transmit the plurality of goals to a governmental agency to fulfill legal obligations related to submission of school campus goals;
an objective transmitter, responsive to the objective creator, to transmit the plurality of objectives to a governmental agency to fulfill legal obligations related to submission of school campus objectives; and
a strategy transmitter, responsive to the strategy creator, to transmit the plurality of strategies to a governmental agency to fulfill legal obligations related to submission of school campus strategies.

8. A system to enhance financial budgeting of an organization having a plurality of departments for a preselected future fiscal term to thereby integrate financial budgeting with strategic planning, the system comprising:
a computer defining a server and having a database and memory associated therewith, the server adapted to interface with a communication network;
an organization administrative computer adapted to interface with the communication network and an organization user, the organization administrative computer being remote from and in communication with the server through the communication network;
a plurality of department client computers each adapted to interface with the communication network and a department user, each of the plurality of department client computers being remote from and in communication with the server through the communication network; and
a program product stored in the memory of the server and adapted to be accessible by the organization administrative computer and the department client computers, the program product having instructions comprising:
(a) a minimum budget assignor, responsive to organization user input commands, to assign to one of the plurality of departments a minimum budget amount of money determined by the organization so that the department expects to receive at least a minimum amount of money for the fiscal term, the minimum budget amount of money defining a final non-negotiated amount of money allocated from the organization to the department for the fiscal term,
(b) a strategy creator, responsive to department user input commands, to create a plurality of strategies for the department,
(c) a strategy assignor, responsive to the plurality of strategies and department user input commands, to assign a priority ranking determined by the department to each of the plurality of strategies to define a plurality of prioritized strategies,
(d) a supplemental budget requestor, responsive to the plurality of prioritized strategies and department user input commands, to submit a plurality of supplemental budget requests for the plurality of prioritized strategies by the department for a requested supplemental amount of money for each of the plurality of supplemental budget requests of the department for review and approval by the organization, the requested supplemental budget amount of money defining a negotiable amount of money independent of the non-negotiable amount of money that is requested from the organization by the department, and
(e) a supplemental budget assignor, responsive to the supplemental budget request and the plurality of prioritized strategies and organization user input commands, to assign to the department a supplemental budget amount of money determined by the organization for at least some of the plurality of prioritized strategies, the supplemental budget amount of money defining a final negotiated amount of money independent of the non-negotiable amount of money that is allocated from the organization to the department for the fiscal term.

9. A system as defined in claim 8, wherein the organization comprises a school district and the plurality of departments comprise a plurality of school campuses.

10. A system as defined in claim 8, wherein the program product has instructions further comprising:
a budget scheduler, responsive to department user input commands, to create a budget schedule for the fiscal term determined by the department, the budget schedule defining a plurality of budget items and a budget cost for each of the plurality of budget items;
a minimum budget indicator, responsive to the minimum budget amount of money and the budget scheduler and department user input commands, to indicate on the budget schedule of the department when the sum of the budget costs for the plurality of budget items on the budget schedule exceeds the minimum budget amount of money allocated to the department as determined by the organization, wherein the minimum budget amount of money comprises a selected percentage amount of a previous year's budget for the department; and
a budget item indicator, responsive to a previous year's budget cost for a particular budget item and the budget scheduler and department user input commands, to indicate on the budget schedule of the department when the budget cost for the particular budget item exceeds the previous year's budget cost for the particular budget item.

11. A system as defined in claim 8, wherein the program product has instructions further comprising:
a goal creator, responsive to department user input commands, to create a plurality of goals for the department;
a goal storer, responsive to user input commands, to create a goal depository and to assign a plurality of preselected goals to the goal depository for storage in the goal depository;
a goal accessor, responsive to user input commands, to access at least one of the plurality of goals from the goal depository and to assign the goal to the department; and
an objective creator, responsive to the plurality of goals and department user input commands, to create a plurality of objectives for each of the plurality of goals;
wherein the strategies created by the strategy creator correspond to each of the plurality of objectives of each of the plurality of goals.

12. A system as defined in claim 8:
wherein the strategy assignor further comprises instructions to assign a reasoned justification determined by the department that supports the necessity for a particular strategy to each of the plurality of strategies, and wherein the priority ranking assigned by the strategy assignor to each of the plurality of strategies is based upon the reasoned justification;
wherein the strategy assignor further comprises instructions to assign priority rankings to each of the plurality of strategies by having each of a plurality of voters selected by the department assign a numerical value in a preselected range of values to each of the plurality of strategies, wherein each of the plurality of voters comprises one or more individuals selected by the department;
a vote valuator, responsive to the strategy assignor, to define the preselected range of values as being values of zero, one, and two;
a vote assignor, responsive to a particular strategy and each of the plurality of voters representing the department, to assign a value of zero to the particular strategy for each of the plurality of voters that regards the particular strategy as unimportant, to assign a value of one to the particular strategy for each of the plurality of voters that regards the particular strategy as moderately important, to assign a value of two to the particular strategy for each of the plurality of voters that regards the particular strategy as very important, to determine the sum of each of the values assigned to the particular strategy by each of the plurality of voters to define a total priority value for the particular strategy, and to assign a particular priority ranking to the particular strategy responsive to comparing the total priority value for the particular strategy with total priority values for other strategies of the department; and
a strategy submitter, responsive to the plurality of prioritized strategies and reasoned justifications and department user input commands, to submit by the department the reasoned justifications and prioritized strategies for the plurality of strategies to the organization.

13. A system as defined in claim 8, wherein the program product has instructions further comprising:
a goal transmitter, responsive to the goal creator, to transmit the plurality of goals to a governmental agency to fulfill legal obligations related to submission of department goals;
an objective transmitter, responsive to the objective creator, to transmit the plurality of objectives to a governmental agency to fulfill legal obligations related to submission of department objectives;
a strategy transmitter, responsive to the strategy creator, to transmit the plurality of strategies to a governmental agency to fulfill legal obligations related to submission of department strategies; and
a budget reporter, responsive to the final non-negotiated amount of money and the final negotiated amount of money, to create a report indicating the final non-negotiated amount of money and the final negotiated amount of money for the fiscal term to thereby inform individuals within the organization and the department of the amount of money available for the fiscal term.

14. A program product embodied in a computer-readable medium to enhance financial budgeting of an organization having a plurality of departments, the program product having instructions comprising:
a minimum budget assignor, responsive to organization user input commands, to assign to one of the plurality of departments a minimum budget amount of money determined by the organization so that the department expects to receive at least a minimum amount of money for a fiscal term, the minimum budget amount of money defining a final non-negotiated amount of money allocated from the organization to the department for the fiscal term;
a strategy creator, responsive to department user input commands, to create a plurality of strategies for the department;
a strategy assignor, responsive to the plurality of strategies and department user input commands, to assign a priority ranking determined by the department to each of the plurality of strategies to define a plurality of prioritized strategies;
a supplemental budget requester, responsive to the plurality of prioritized strategies and department user input commands, to submit a plurality of supplemental budget requests for the plurality of prioritized strategies by the department for a requested supplemental amount of money for each of the plurality of supplemental budget requests of the department for review and approval by the organization, the requested supplemental budget amount of money defining a negotiable amount of money independent of the non-negotiable amount of money that is requested from the organization by the department; and
a supplemental budget assignor, responsive to the supplemental budget request and the plurality of prioritized strategies and organization user input commands, to assign to the department a supplemental budget amount of money determined by the organization for at least some of the plurality of prioritized strategies, the supplemental budget amount of money defining a final negotiated amount of money independent of the non-negotiable amount of money that is allocated from the organization to the department for the fiscal term.

15. A program product as defined in claim 14, wherein the organization comprises a school district and the plurality of departments comprise a plurality of school campuses.

16. A program product as defined in claim 14, further comprising:
a budget scheduler, responsive to department user input commands, to create a budget schedule for the fiscal term determined by the department, the budget schedule defining a plurality of budget items and a budget cost for each of the plurality of budget items;
a minimum budget indicator, responsive to the minimum budget amount of money and the budget scheduler and department user input commands, to indicate on the budget schedule of the department when the sum of the budget costs for the plurality of budget items on the budget schedule exceeds the minimum budget amount of money allocated to the department as determined by the organization, wherein the minimum budget amount of money comprises a selected percentage amount of a previous year's budget for the department; and
a budget item indicator, responsive to a previous year's budget cost for a particular budget item and the budget scheduler and department user input commands, to indicate on the budget schedule of the department when the budget cost for the particular budget item exceeds the previous year's budget cost for the particular budget item.

17. A program product as defined in claim 14, further comprising:
a goal creator, responsive to department user input commands, to create a plurality of goals for the department;
a goal storer, responsive to user input commands, to create a goal depository and to assign a plurality of preselected goals to the goal depository for storage in the goal depository;
a goal accessor, responsive to user input commands, to access at least one of the plurality of goals from the goal depository and to assign the goal to the department;
an objective creator, responsive to the plurality of goals and department user input commands, to create a plurality of objectives for each of the plurality of goals; and
wherein the strategies created by the strategy creator correspond to each of the plurality of objectives of each of the plurality of goals.

18. A program product as defined in claim 14:
wherein the strategy assignor further comprises instructions to assign a reasoned justification determined by the department that supports the necessity for a particular strategy to each of the plurality of strategies, and wherein the priority ranking assigned by the strategy assignor to each of the plurality of strategies is based upon the reasoned justification;
wherein the strategy assignor further comprises instructions to assign priority rankings to each of the plurality of strategies by having each of a plurality of voters selected by the department assign a numerical value in a preselected range of values to each of the plurality of strategies, wherein each of the plurality of voters comprises one or more individuals selected by the department;
a vote valuator, responsive to the strategy assignor, to define the preselected range of values as being values of zero, one, and two;
a vote assignor, responsive to a particular strategy and each of the plurality of voters representing the department, to assign a value of zero to the particular strategy for each of the plurality of voters that regards the particular strategy as unimportant, to assign a value of one to the particular strategy for each of the plurality of voters that regards the particular strategy as moderately important, to assign a value of two to the particular strategy for each of the plurality of voters that regards the particular strategy as very important, to determine the sum of each of the values assigned to the particular strategy by each of the plurality of voters to define a total priority value for the particular strategy, and to assign a particular priority ranking to the particular strategy responsive to comparing the total priority value for the particular strategy with total priority values for other strategies of the department; and
a strategy submitter, responsive to the plurality of prioritized strategies and reasoned justifications and department user input commands, to submit by the department the reasoned justifications and prioritized strategies for the plurality of strategies to the organization.

19. A program product as defined in claim 14, further comprising:
a goal transmitter, responsive to the goal creator, to transmit the plurality of goals to a governmental agency to fulfill legal obligations related to submission of department goals;
an objective transmitter, responsive to the objective creator, to transmit the plurality of objectives to a governmental agency to fulfill legal obligations related to submission of department objectives;
a strategy transmitter, responsive to the strategy creator, to transmit the plurality of strategies to a governmental agency to fulfill legal obligations related to submission of department strategies; and
a budget reporter, responsive to the final non-negotiated amount of money and the final negotiated amount of money, to create a report indicating the final non-negotiated amount of money and the final negotiated amount of money for the fiscal term to thereby inform individuals within the organization and the department of the amount of money available for the fiscal term.

20. A method to enhance financial budgeting of an organization having a plurality of departments for a preselected future fiscal term to thereby integrate financial budgeting with strategic planning, the method comprising:
(a) assigning to one of the plurality of departments a minimum budget amount of money determined by the organization so that the department expects to receive at least a minimum amount of money for the fiscal term, the minimum budget amount of money defining a final non-negotiated amount of money allocated from the organization to the department for the fiscal term;
(b) creating a plurality of strategies for the department;
(c) assigning a priority ranking determined by the department to each of the plurality of strategies to define a plurality of prioritized strategies;
(d) submitting a plurality of supplemental budget requests for the plurality of prioritized strategies by the department for a requested supplemental amount of money for each of the plurality of supplemental budget requests of the department for review and approval by the organization, the requested supplemental budget amount of money defining a negotiable amount of money independent of the non-negotiable amount of money that is requested from the organization by the department; and
(e) assigning to the department a supplemental budget amount of money determined by the organization for at least some of the plurality of prioritized strategies, the supplemental budget amount of money defining a final negotiated amount of money independent of the non-negotiable amount of money that is allocated from the organization to the department for the fiscal term.

21. A method as defined in claim 20, wherein the organization comprises a school district and the plurality of departments comprise a plurality of school campuses.

22. A method as defined in claim 20, further comprising:
creating a budget schedule for the fiscal term determined by the department, the budget schedule defining a plurality of budget items and a budget cost for each of the plurality of budget items;
indicating on the budget schedule of the department when the sum of the budget costs for the plurality of budget items on the budget schedule exceeds the minimum budget amount of money allocated to the department as determined by the organization, wherein the minimum budget amount of money comprises a selected percentage amount of a previous year's budget for the department; and
indicating on the budget schedule of the department when the budget cost for the particular budget item exceeds the previous year's budget cost for the particular budget item.

23. A method as defined in claim 20, further comprising:
creating a plurality of goals for the department;
creating a goal depository and assigning a plurality of preselected goals to the goal depository for storage in the goal depository;
accessing at least one of the plurality of goals from the goal depository and assigning the goal to the department;
creating a plurality of objectives for each of the plurality of goals; and
wherein the strategies created by the strategy creator correspond to each of the plurality of objectives of each of the plurality of goals.

24. A method as defined in claim 20, wherein step (c) further comprises:
assigning a reasoned justification determined by the department that supports the necessity for a particular strategy to each of the plurality of strategies, wherein the priority ranking assigned by the strategy assignor to each of the plurality of strategies is based upon the reasoned justification;
assigning priority rankings to each of the plurality of strategies by having each of a plurality of voters selected by the department assign a numerical value in a preselected range of values to each of the plurality of strategies, wherein each of the plurality of voters comprises one or more individuals selected by the school campus;
defining the preselected range of values as being values of zero, one, and two;
assigning a value of zero to the particular strategy for each of the plurality of voters that regards the particular strategy as unimportant, assigning a value of one to the particular strategy for each of the plurality of voters that regards the particular strategy as moderately important, and assigning a value of two to the particular strategy for each of the plurality of voters that regards the particular strategy as very important;
determining the sum of each of the values assigned to the particular strategy by each of the plurality of voters to define a total priority value for the particular strategy;
assigning a particular priority ranking to the particular strategy responsive to comparing the total priority value for the particular strategy with total priority values for other strategies of the department; and
submitting by the department the reasoned justifications and prioritized strategies for the plurality of strategies to the organization.

25. A method as defined in claim 20, further comprising:
transmitting the plurality of goals to a governmental agency to fulfill legal obligations related to submission of department goals;
transmitting the plurality of objectives to a governmental agency to fulfill legal obligations related to submission of department objectives;
transmitting the plurality of strategies to a governmental agency to fulfill legal obligations related to submission of department strategies; and
creating a report indicating the final non-negotiated amount of money and the final negotiated amount of money for the fiscal term to thereby inform individuals within the organization and the department of the amount of money available for the fiscal term.

26. A computer memory element containing a database stored in signal bearing media, the database containing the following data in computer-readable format:
data indicating an organizational structure, including data indicating an organization having a plurality of departments;
data indicating minimum budget allocation information for a preselected future fiscal term, including data indicating a minimum budget amount of money determined by the organization that the department is guaranteed for the fiscal term, the minimum budget amount of money defining a final non-negotiated amount of money allocated from the organization to the department for the fiscal term;
data indicating a plurality of strategies each having a priority ranking determined by the department to define a plurality of prioritized strategies;
data indicating supplemental budget request information for the fiscal term, including data indicating a plurality of supplemental budget requests for the plurality of prioritized strategies by the department for a requested supplemental amount of money for each of the plurality of supplemental budget requests of the department for review and approval by the organization, the requested supplemental budget amount of money defining a negotiable amount of money independent of the non-negotiable amount of money that is requested from the organization by the department; and
data indicating supplemental budget allocation information for the fiscal term, including data indicating a supplemental budget amount of money determined by the organization that is allocated to the department for at least some of the plurality of prioritized strategies, the supplemental budget amount of money defining a final negotiated amount of money independent of the non-negotiable amount of money that is allocated from the organization to the department for the fiscal term.

27. A computer memory element as defined in claim 26, wherein the organization comprises a school district and the plurality of departments comprise a plurality of school campuses.

28. A computer memory element as defined in claim 26, wherein the database further includes data indicating a reasoned justification determined by the department for each of the plurality of strategies that supports the necessity for a particular strategy, and wherein the priority ranking of each of the plurality of strategies is based upon the reasoned justification.

29. A computer memory element as defined in claim 26, wherein the database further includes data indicating a report indicating the final non-negotiated amount of money and the final negotiated amount of money for the fiscal term.
